(19) United States
(12) Patent Application Publication
(10) Pub. No.: US 2007/0101313 A1
(43) Pub. Date: May 3, 2007

(54) Publishing synthesized RSS content as an audio file

(76) Inventors: William K. Bodin, Austin, TX (US); David Jaramillo, Lake Worth, FL (US); Jerry W. Redman, Cedar Park, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/266,675

(22) Filed: Nov. 3, 2005

(51) Int. Cl. G06F 9/44

(52) U.S. Cl. 717/114

(57) ABSTRACT

Methods, systems, and products are disclosed for publishing synthesized RSS content as an audio file which include selecting synthesized RSS content; selecting a file type; converting the text and markup of the synthesized RSS content to waveform data of the selected file type, the waveform data containing speech presentation of the synthesized RSS content; and recording the waveform data of the selected file type. Publishing synthesized RSS content as an audio file may also include transferring the recorded waveform data of the selected file type to a recording medium for playback.

### BACKGROUND OF THE INVENTION

1. Field of the Invention

The field of the invention is data processing, or, more specifically, methods, systems, and products for publishing synthesized RSS content as an audio file.

2. Description of Related Art

Despite having more access to data and having more devices to access that data, users are often time constrained. One reason for this time constraint is that users typically must access data of disparate data types from disparate data sources on data type-specific devices using data type-specific applications. One or more such data type-specific devices may be cumbersome for use at a particular time due to any number of external circumstances. Examples of external circumstances that may make data type-specific devices cumbersome to use include crowded locations, uncomfortable locations such as a train or car, user activity such as walking, visually intensive activities such as driving, and others as will occur to those of skill in the art. There is therefore an ongoing need for data management and data rendering for disparate data types that provides access to uniform data type access to content from disparate data sources.

### SUMMARY OF THE INVENTION

Methods, systems, and products are disclosed for publishing synthesized RSS content as an audio file which include selecting synthesized RSS content; selecting a file type; converting the text and markup of the synthesized RSS content to waveform data of the selected file type, the waveform data containing speech presentation of the synthesized RSS content; and recording the waveform data of the selected file type. Publishing synthesized RSS content as an audio file may also include transferring the recorded waveform data of the selected file type to a recording medium for playback.

Selecting synthesized RSS content may also include selecting a synthesized RSS item. Converting the text and markup of the synthesized RSS content to waveform data of the selected file type may also include converting the text and markup of the synthesized RSS content to waveform data of a selected file type in dependence upon waveform conversion preferences. Converting the text and markup of the synthesized RSS content to waveform data of the selected file type may also include identifying one or more components of a synthesized RSS item to be recorded as an auditory magazine clipping. Transferring the recorded waveform data of the selected file type to a recording medium for playback may also include creating an audio compact disk having tracks, including creating a track layout for audio data to be recorded and writing the recorded waveform data to the audio compact disk as a track in dependence upon the track layout. Transferring the recorded waveform data of the selected file type to a recording medium for playback may also include inserting the recorded waveform data in a location in an ordered series of recorded RSS items in dependence upon RSS item ordering criteria. Recording the waveform data of the selected file type may also include naming the recorded waveform data for identifying the RSS content.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for data management and data rendering for disparate data types according to embodiments of the present invention.

FIG. 2 sets forth a block diagram of automated computing machinery comprising an exemplary computer useful in data management and data rendering for disparate data types according to embodiments of the present invention.

FIG. 3 sets forth a block diagram depicting a system for data management and data rendering for disparate data types according to of the present invention.

FIG. 4 sets forth a flow chart illustrating an exemplary method for data management and data rendering for disparate data types according to embodiments of the present invention.

FIG. 5 sets forth a flow chart illustrating an exemplary method for aggregating data of disparate data types from disparate data sources according to embodiments of the present invention.

FIG. 6 sets forth a flow chart illustrating an exemplary method for retrieving, from the identified data source, the requested data according to embodiments of the present invention.

FIG. 7 sets forth a flow chart illustrating an exemplary method for aggregating data of disparate data types from disparate data sources according to the present invention.

FIG. 8 sets forth a flow chart illustrating an exemplary method for aggregating data of disparate data types from disparate data sources according to the present invention.

FIG. 9 sets forth a flow chart illustrating a exemplary method for synthesizing aggregated data of disparate data types into data of a uniform data type according to the present invention.

FIG. 10 sets forth a flow chart illustrating a exemplary method for synthesizing aggregated data of disparate data types into data of a uniform data type according to the present invention.

FIG. 11 sets forth a flow chart illustrating an exemplary method for identifying an action in dependence upon the synthesized data according to the present invention.

FIG. 12 sets forth a flow chart illustrating an exemplary method for channelizing (422) the synthesized data (416) according to the present invention.

FIG. 13 sets forth a flow chart illustrating an exemplary method for publishing synthesized RSS content as an audio file according to the present invention.

FIG. 14 sets forth a flow chart further illustrating exemplary methods for selecting synthesized RSS content, converting the text and markup of the synthesized RSS content to waveform data of the selected file type, and recording the waveform data of the selected file type according to the present invention.

FIG. 15 sets forth a flow chart further illustrating an exemplary method for transferring recorded waveform data of a selected file type to a recording medium for playback.

### DETAILED DESCRIPTION OF EXEMPLARY EMBODIMENTS

### Exemplary Architecture for Data Management and Data Rendering for Disparate Data Types

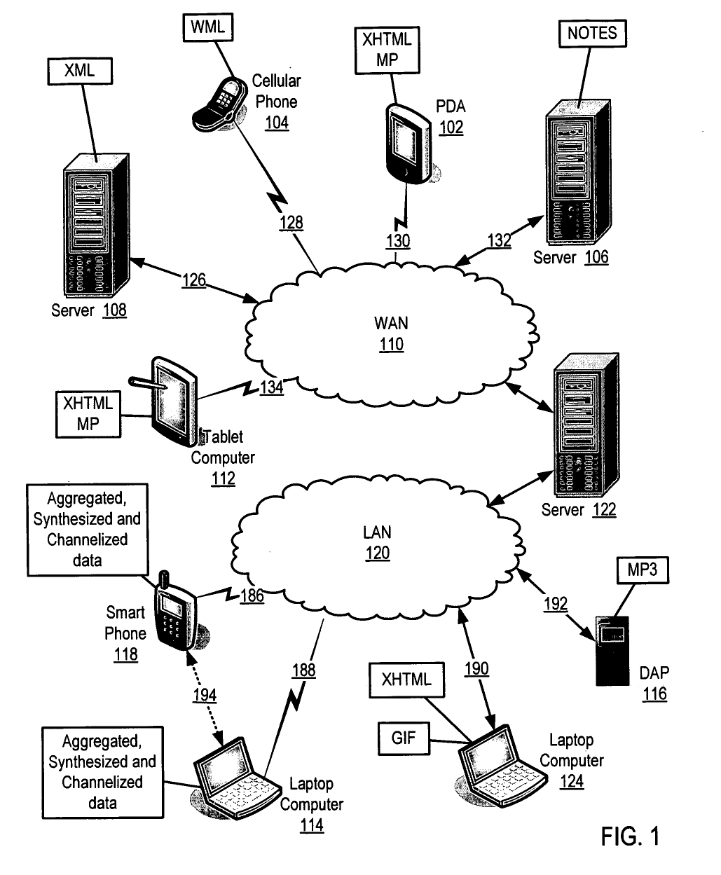

Exemplary methods, systems, and products for data management and data rendering for disparate data types from disparate data sources according to embodiments of the present invention are described with reference to the accompanying drawings, beginning with FIG. 1. FIG. 1 sets forth a network diagram illustrating an exemplary system for data management and data rendering for disparate data types according to the present invention. The system of FIG. 1 operates generally to manage and render data for disparate data types according to embodiments of the present invention by aggregating data of disparate data types from disparate data sources, synthesizing the aggregated data of disparate data types into data of a uniform data type, identifying an action in dependence upon the synthesized data, and executing the identified action.

Disparate data types are data of different kind and form. That is, disparate data types are data of different kinds. The distinctions in data that define the disparate data types may include a difference in data structure, file format, protocol in which the data is transmitted, and other distinctions as will occur to those of skill in the art. Examples of disparate data types include MPEG-1 Audio Layer 3 (‘MP3’) files, Extensible markup language documents (‘XML’), email documents, and so on as will occur to those of skill in the art. Disparate data types typically must be rendered on data type-specific devices. For example, an MPEG-1 Audio Layer 3 (‘MP3’) file is typically played by an MP3 player, a Wireless Markup Language (‘WML’) file is typically accessed by a wireless device, and so on.

The term disparate data sources means sources of data of disparate data types. Such data sources may be any device or network location capable of providing access to data of a disparate data type. Examples of disparate data sources include servers serving up files, web sites, cellular phones, PDAs, MP3 players, and so on as will occur to those of skill in the art.

The system of FIG. 1 includes a number of devices operating as disparate data sources connected for data communications in networks. The data processing system of FIG. 1 includes a wide area network (“WAN”) (110) and a local area network (“LAN”) (120). “LAN” is an abbreviation for “local area network.” A LAN is a computer network that spans a relatively small area. Many LANs are confined to a single building or group of buildings. However, one LAN can be connected to other LANs over any distance via telephone lines and radio waves. A system of LANs connected in this way is called a wide-area network (WAN). The Internet is an example of a WAN.

In the example of FIG. 1, server (122) operates as a gateway between the LAN (120) and the WAN (110). The network connection aspect of the architecture of FIG. 1 is only for explanation, not for limitation. In fact, systems for data management and data rendering for disparate data types according to embodiments of the present invention may be connected as LANs, WANs, intranets, intemets, the Internet, webs, the World Wide Web itself, or other connections as will occur to those of skill in the art. Such networks are media that may be used to provide data communications connections between various devices and computers connected together within an overall data processing system.

In the example of FIG. 1, a plurality of devices are connected to a LAN and WAN respectively, each implementing a data source and each having stored upon it data of a particular data type. In the example of FIG. 1, a server (108) is connected to the WAN through a wireline connection (126). The server (108) of FIG. 1 is a data source for an RSS feed, which the server delivers in the form of an XML file. RSS is a family of XML file formats for web syndication used by news websites and weblogs. The abbreviation is used to refer to the following standards: Rich Site Summary (RSS 0.91), RDF Site Summary (RSS 0.9, 1.0 and 1.1), and Really Simple Syndication (RSS 2.0). The RSS formats provide web content or summaries of web content together with links to the full versions of the content, and other meta-data. This information is delivered as an XML file called RSS feed, webfeed, RSS stream, or RSS channel.

In the example of FIG. 1, another server (106) is connected to the WAN through a wireline connection (132). The server (106) of FIG. 1 is a data source for data stored as a Lotus NOTES file. In the example of FIG. 1, a personal digital assistant (‘PDA’) (102) is connected to the WAN through a wireless connection (130). The PDA is a data source for data stored in the form of an XHTML Mobile Profile (‘XHTML MP’) document. In the example of FIG. 1, a cellular phone (104) is connected to the WAN through a wireless connection (128). The cellular phone is a data source for data stored as a Wireless Markup Language (‘WML’) file. In the example of FIG. 1, a tablet computer (112) is connected to the WAN through a wireless connection (134). The tablet computer (112) is a data source for data stored in the form of an XHTML MP document.

The system of FIG. 1 also includes a digital audio player (‘DAP’) (116). The DAP (116) is connected to the LAN through a wireline connection (192). The digital audio player (‘DAP’) (116) of FIG. 1 is a data source for data stored as an MP3 file. The system of FIG. 1 also includes a laptop computer (124). The laptop computer is connected to the LAN through a wireline connection (190). The laptop computer (124) of FIG. 1 is a data source data stored as a Graphics Interchange Format (‘GIF’) file. The laptop computer (124) of FIG. 1 is also a data source for data in the form of Extensible Hypertext Markup Language (‘XHTML’) documents.

The system of FIG. 1 includes a laptop computer (114) and a smart phone (118) each having installed upon it a data management and rendering module proving //AUS920050521US1 Patent Application uniform access to the data of disparate data types available from the disparate data sources. The exemplary laptop computer (114) of FIG. 1 connects to the LAN through a wireless connection (188). The exemplary smart phone (118) of FIG. 1 also connects to the LAN through a wireless connection (186). The laptop computer (114) and smart phone (118) of FIG. 1 have installed and running on them software capable generally of data management and data rendering for disparate data types by aggregating data of disparate data types from disparate data sources; synthesizing the aggregated data of disparate data types into data of a uniform data type; identifying an action in dependence upon the synthesized data; and executing the identified action.

Aggregated data is the accumulation, in a single location, of data of disparate types. This location of the aggregated data may be either physical, such as, for example, on a single computer containing aggregated data, or logical, such as, for example, a single interface providing access to the aggregated data.

Synthesized data is aggregated data which has been synthesized into data of a uniform data type. The uniform data type may be implemented as text content and markup which has been translated from the aggregated data. Synthesized data may also contain additional voice markup inserted into the text content, which adds additional voice capability.

Alternatively, any of the devices of the system of FIG. 1 described as sources may also support a data management and rendering module according to the present invention. For example, the server (106), as described above, is capable of supporting a data management and rendering module providing uniform access to the data of disparate data types available from the disparate data sources. Any of the devices of FIG. 1, as described above, such as, for example, a PDA, a tablet computer, a cellular phone, or any other device as will occur to those of skill in the art, are capable of supporting a data management and rendering module according to the present invention.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

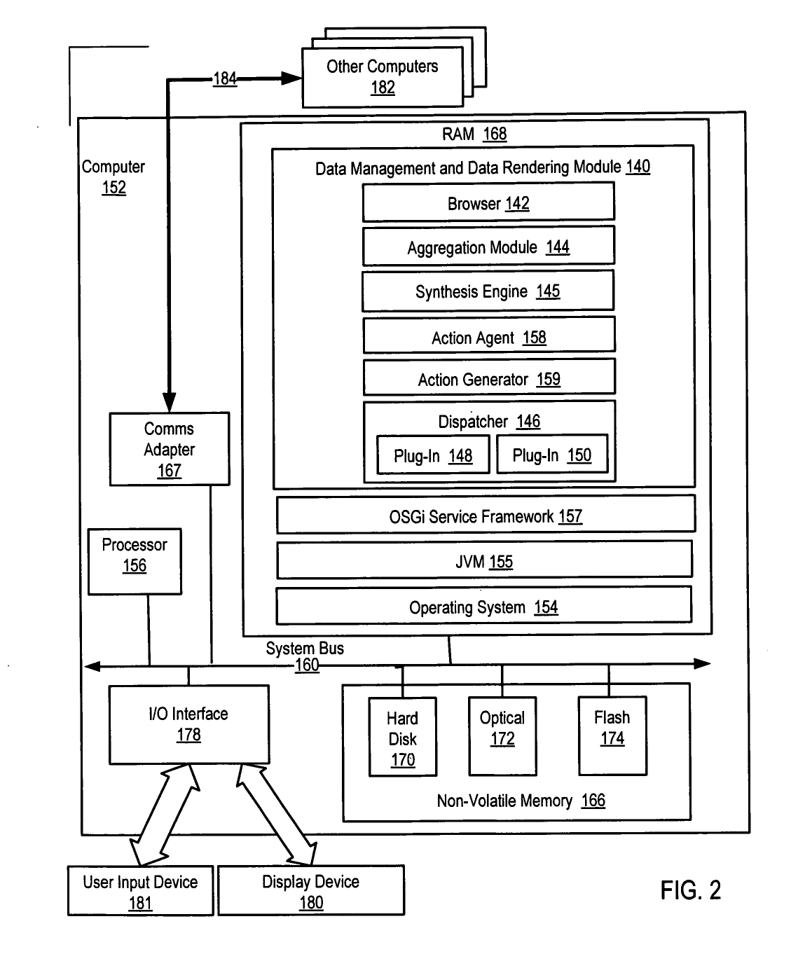

A method for data management and data rendering for disparate data types in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in data management and data rendering for disparate data types according to embodiments of the present invention. The computer (152) of FIG. 2 includes at least one computer processor (156) or ‘CPU’ as well as random access memory (168) (‘RAM’) which is connected through a system bus (160) to a processor (156) and to other components of the computer.

Stored in RAM (168) is a data management and data rendering module (140), computer program instructions for data management and data rendering for disparate data types capable generally of aggregating data of disparate data types from disparate data sources; synthesizing the aggregated data of disparate data types into data of a uniform data type; identifying an action in dependence upon the synthesized data; and executing the identified action. Data management and data rendering for disparate data types advantageously provides to the user the capability to efficiently access and manipulate data gathered from disparate data type-specific resources. Data management and data rendering for disparate data types also provides a uniform data type such that a user may access data gathered from disparate data type-specific resources on a single device.

The data management and data rendering module (140) of FIG. 2 also includes computer program instructions for publishing synthesized RSS content as an audio file which include selecting synthesized RSS content; selecting a file type; converting the text and markup of the synthesized RSS content to waveform data of the selected file type, the waveform data containing speech presentation of the synthesized RSS content; and recording the waveform data of the selected file type.

Also stored in RAM (168) is an aggregation module (144), computer program instructions for aggregating data of disparate data types from disparate data sources capable generally of receiving, from an aggregation process, a request for data; identifying, in response to the request for data, one of two or more disparate data sources as a source for data; retrieving, from the identified data source, the requested data; and returning to the aggregation process the requested data. Aggregating data of disparate data types from disparate data sources advantageously provides the capability to collect data from multiple sources for synthesis.

Also stored in RAM is a synthesis engine (145), computer program instructions for synthesizing aggregated data of disparate data types into data of a uniform data type capable generally of receiving aggregated data of disparate data types and translating each of the aggregated data of disparate data types into translated data composed of text content and markup associated with the text content. Synthesizing aggregated data of disparate data types into data of a uniform data type advantageously provides synthesized data of a uniform data type which is capable of being accessed and manipulated by a single device.

Also stored in RAM (168) is an action generator module (159), a set of computer program instructions for identifying actions in dependence upon synthesized data and often user instructions. Identifying an action in dependence upon the synthesized data advantageously provides the capability of interacting with and managing synthesized data.

Also stored in RAM (168) is an action agent (158), a set of computer program instructions for administering the execution of one or more identified actions. Such execution may be executed immediately upon identification, periodically after identification, or scheduled after identification as will occur to those of skill in the art.

Also stored in RAM (168) is a dispatcher (146), computer program instructions for receiving, from an aggregation process, a request for data; identifying, in response to the request for data, one of a plurality of disparate data sources as a source for the data; retrieving, from the identified data source, the requested data; and returning, to the aggregation process, the requested data. Receiving, from an aggregation process, a request for data; identifying, in response to the request for data, one of a plurality of disparate data sources as a source for the data; retrieving, from the identified data source, the requested data; and returning, to the aggregation process, the requested data advantageously provides the capability to access disparate data sources for aggregation and synthesis.

The dispatcher (146) of FIG. 2 also includes a plurality of plug-in modules (148, 150), computer program instructions for retrieving, from a data source associated with the plug-in, requested data for use by an aggregation process. Such plug-ins isolate the general actions of the dispatcher from the specific requirements needed to retrieved data of a particular type.

Also stored in RAM (168) is a browser (142), computer program instructions for providing an interface for the user to synthesized data. Providing an interface for the user to synthesized data advantageously provides a user access to content of data retrieved from disparate data sources without having to use data source-specific devices. The browser (142) of FIG. 2 is capable of multimodal interaction capable of receiving multimodal input and interacting with users through multimodal output. Such multimodal browsers typically support multimodal web pages that provide multimodal interaction through hierarchical menus that may be speech driven.

Also stored in RAM is an OSGi Service Framework (157) running on a Java Virtual Machine (‘JVM’) (155). “OSGi” refers to the Open Service Gateway initiative, an industry organization developing specifications delivery of service bundles, software middleware providing compliant data communications and services through services gateways. The OSGi specification is a Java based application layer framework that gives service providers, network operator device makers, and appliance manufacturer's vendor neutral application and device layer APIs and functions. OSGi works with a variety of networking technologies like Ethernet, Bluetooth, the ‘Home, Audio and Video Interoperability standard’ (HAVi), IEEE 1394, Universal Serial Bus (USB), WAP, X-10, Lon Works, HomePlug and various other networking technologies. The OSGi specification is available for free download from the OSGi website at www.osgi.org.

An OSGi service framework (157) is written in Java and therefore, typically runs on a Java Virtual Machine (JVM) (155). In OSGi, the service framework (157) is a hosting platform for running ‘services’. The term ‘service’ or ‘services’ in this disclosure, depending on context, generally refers to OSGi-compliant services.

Services are the main building blocks for creating applications according to the OSGi. A service is a group of Java classes and interfaces that implement a certain feature. The OSGi specification provides a number of standard services. For example, OSGi provides a standard HTTP service that creates a web server that can respond to requests from HTTP clients.

OSGi also provides a set of standard services called the Device Access Specification.

The Device Access Specification (“DAS”) provides services to identify a device connected to the services gateway, search for a driver for that device, and install the driver for the device.

Services in OSGi are packaged in ‘bundles’ with other files, images, and resources that the services need for execution. A bundle is a Java archive or ‘JAR’ file including one or more service implementations, an activator class, and a manifest file. An activator class is a Java class that the service framework uses to start and stop a bundle. A manifest file is a standard text file that describes the contents of the bundle.

The service framework (157) in OSGi also includes a service registry. The service registry includes a service registration including the service's name and an instance of a class that implements the service for each bundle installed on the framework and registered with the service registry. A bundle may request services that are not included in the bundle, but are registered on the framework service registry. To find a service, a bundle performs a query on the framework's service registry.

Data management and data rendering according to embodiments of the present invention may be usefully invoke one ore more OSGi services. OSGi is included for explanation and not for limitation. In fact, data management and data rendering according embodiments of the present invention may usefully employ many different technologies an all such technologies are well within the scope of the present invention.

Also stored in RAM (168) is an operating system (154). Operating systems useful in computers according to embodiments of the present invention include UNIX™, Linux™, Microsoft Windows NT™, AIX™, IBM‘s i5/OSTM, and others as will occur to those of skill in the art. The operating system (154) and data management and data rendering module (140) in the example of FIG. 2 are shown in RAM (168), but many components of such software typically are stored in non-volatile memory (166) also.

Computer (152) of FIG. 2 includes non-volatile computer memory (166) coupled through a system bus (160) to a processor (156) and to other components of the computer (152). Non-volatile computer memory (166) may be implemented as a hard disk drive (170), an optical disk drive (172), an electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as a USB, through data communications networks such as IP networks, and in other ways as will occur to those of skill in the art. Communications adapters implement the hardware level of data communications through which one computer sends data communications to another computer, directly or through a network. Examples of communications adapters useful for data management and data rendering for disparate data types from disparate data sources according to embodiments of the present invention include modems for wired dial-up communications, Ethernet (IEEE 802.3) adapters for wired network communications, and 802.11 b adapters for wireless network communications.

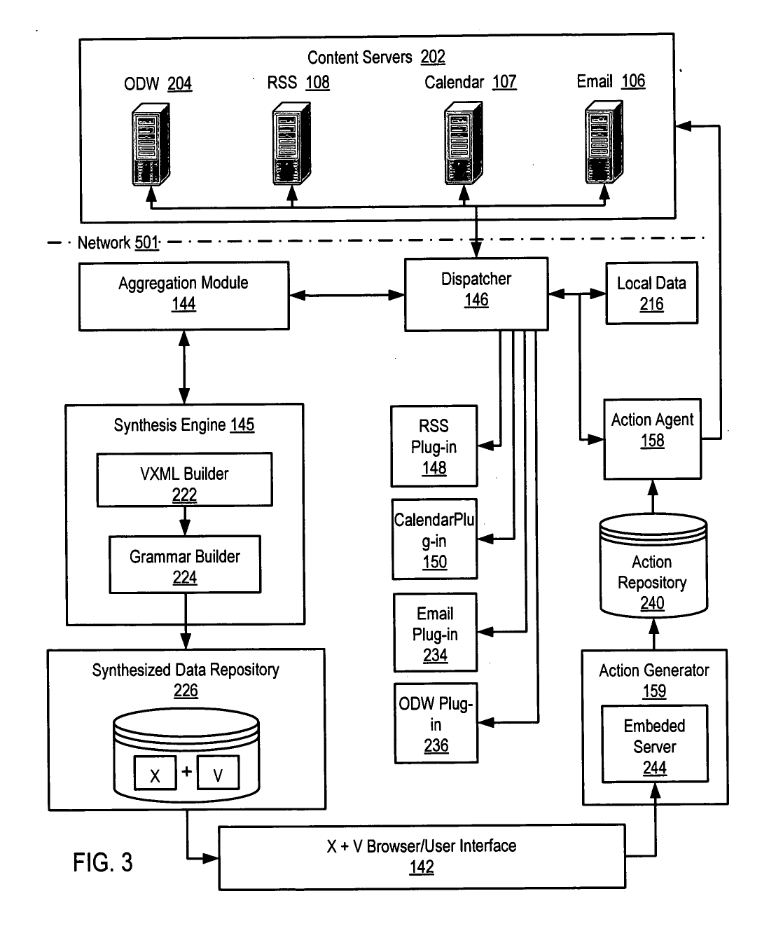

For further explanation, FIG. 3 sets forth a block diagram depicting a system for data management and data rendering for disparate data types according to of the present invention. The system of FIG. 3 includes an aggregation module (144), computer program instructions for aggregating data of disparate data types from disparate data sources capable generally of receiving, from an aggregation process, a request for data; identifying, in response to the request for data, one of two or more disparate data sources as a source for data; retrieving, from the identified data source, the requested data; and returning to the aggregation process the requested data.

The system of FIG. 3 includes a synthesis engine (145), computer program instructions for synthesizing aggregated data of disparate data types into data of a uniform data type capable generally of receiving aggregated data of disparate data types and translating each of the aggregated data of disparate data types into translated data composed of text content and markup associated with the text content.

The synthesis engine (145) includes a VXML Builder (222) module, computer program instructions for translating each of the aggregated data of disparate data types into text content and markup associated with the text content. The synthesis engine (145) also includes a grammar builder (224) module, computer program instructions for generating grammars for voice markup associated with the text content.

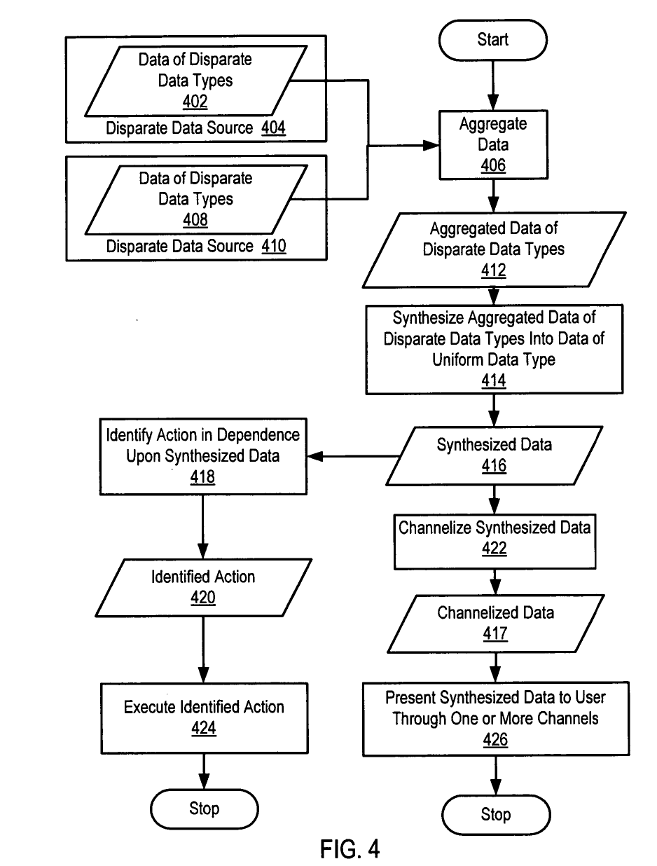

The system of FIG. 3 includes a synthesized data repository (226) data storage for the synthesized data created by the synthesis engine in X+V format. The system of FIG. 3 also includes an X+V browser (142), computer program instructions capable generally of presenting the synthesized data from the synthesized data repository (226) to the user. Presenting the synthesized data may include both graphical display and audio representation of the synthesized data. As discussed below with reference to FIG. 4, one way presenting the synthesized data to a user may be carried out is by presenting synthesized data through one or more channels.

The system of FIG. 3 includes a dispatcher (146) module, computer program instructions for receiving, from an aggregation process, a request for data; identifying, in response to the request for data, one of a plurality of disparate data sources as a source for the data; retrieving, from the identified data source, the requested data; and returning, to the aggregation process, the requested data. The dispatcher (146) module accesses data of disparate data types from disparate data sources for the aggregation module (144), the synthesis engine (145), and the action agent (158). The system of FIG. 3 includes data source-specific plug-ins (148-150, 234-236) used by the dispatcher to access data as discussed below.

In the system of FIG. 3, the data sources include local data (216) and content servers (202). Local data (216) is data contained in memory or registers of the automated computing machinery. In the system of FIG. 3, the data sources also include content servers (202). The content servers (202) are connected to the dispatcher (146) module through a network (501). An RSS server (108) of FIG. 3 is a data source for an RSS feed, which the server delivers in the form of an XML file. RSS is a family of XML file formats for web syndication used by news websites and weblogs. The abbreviation is used to refer to the following standards: Rich Site Summary (RSS 0.91), RDF Site Summary (RSS 0.9, 1.0 and 1.1), and Really Simple Syndication (RSS 2.0). The RSS formats provide web content or summaries of web content together with links to the full versions of the content, and other meta-data. This information is delivered as an XML file called RSS feed, webfeed, RSS stream, or RSS channel.

In the system of FIG. 3, an email server (106) is a data source for email. The server delivers this email in the form of a Lotus NOTES file. In the system of FIG. 3, a calendar server (107) is a data source for calendar information. Calendar information includes calendared events and other related information. The server delivers this calendar information in the form of a Lotus NOTES file.

In the system of FIG. 3, an IBM On Demand Workstation (204) a server providing support for an On Demand Workplace (‘ODW’) that provides productivity tools, and a virtual space to share ideas and expertise, collaborate with others, and find information.

The system of FIG. 3 includes data source-specific plug-ins (148-150, 234-236). For each data source listed above, the dispatcher uses a specific plug-in to access data.

The system of FIG. 3 includes an RSS plug-in (148) associated with an RSS server (108) running an RSS application. The RSS plug-in (148) of FIG. 3 retrieves the RSS feed from the RSS server (108) for the user and provides the RSS feed in an XML file to the aggregation module.

The system of FIG. 3 includes a calendar plug-in (150) associated with a calendar server (107) running a calendaring application. The calendar plug-in (150) of FIG. 3 retrieves calendared events from the calendar server (107) for the user and provides the calendared events to the aggregation module.

The system of FIG. 3 includes an email plug-in (234) associated with an email server (106) running an email application. The email plug-in (234) of FIG. 3 retrieves email from the email server (106) for the user and provides the email to the aggregation module.

The system of FIG. 3 includes an On Demand Workstation (‘ODW’) plug-in (236) associated with an ODW server (204) running an ODW application. The ODW plug-in (236) of FIG. 3 retrieves ODW data from the ODW server (204) for the user and provides the ODW data to the aggregation module.

The system of FIG. 3 also includes an action generator module (159), computer program instructions for identifying an action from the action repository (240) in dependence upon the synthesized data capable generally of receiving a user instruction, selecting synthesized data in response to the user instruction, and selecting an action in dependence upon the user instruction and the selected data.

The action generator module (159) contains an embedded server (244). The embedded server (244) receives user instructions through the X+V browser (142). Upon identifying an action from the action repository (240), the action generator module (159) employs the action agent (158) to execute the action. The system of FIG. 3 includes an action agent (158), computer program instructions for executing an action capable generally of executing actions.

### Data Management and Data Rendering for Disparate Data Types

For further explanation, FIG. 4 sets forth a flow chart illustrating an exemplary method for data management and data rendering for disparate data types according to embodiments of the present invention. The method of FIG. 4 includes aggregating (406) data of disparate data types (402, 408) from disparate data sources (404, 410). As discussed above, aggregated data of disparate data types is the accumulation, in a single location, of data of disparate types. This location of the aggregated data may be either physical, such as, for example, on a single computer containing aggregated data, or logical, such as, for example, a single interface providing access to the aggregated data.

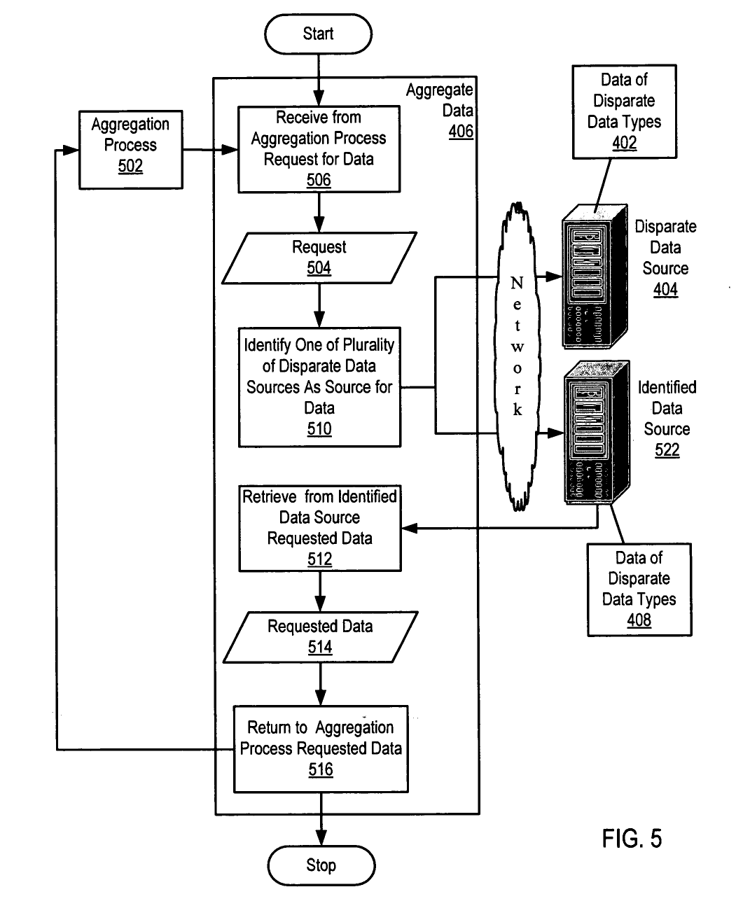

Aggregating (406) data of disparate data types (402, 408) from disparate data sources (404, 410) according to the method of FIG. 4 may be carried out by receiving, from an aggregation process, a request for data; identifying, in response to the request for data, one of two or more disparate data sources as a source for data; retrieving, from the identified data source, the requested data; and returning to the aggregation process the requested data as discussed in more detail below with reference to FIG. 5.

The method of FIG. 4 also includes synthesizing (414) the aggregated data of disparate data types (412) into data of a uniform data type. Data of a uniform data type is data having been created or translated into a format of predetermined type. That is, uniform data types are data of a single kind that may be rendered on a device capable of rendering data of the uniform data type. Synthesizing (414) the aggregated data of disparate data types (412) into data of a uniform data type advantageously results in a single point of access for the content of the aggregation of disparate data retrieved from disparate data sources.

One example of a uniform data type useful in synthesizing (414) aggregated data of disparate data types (412) into data of a uniform data type is XHTML plus Voice. XHTML plus Voice (‘X+V’) is a Web markup language for developing multimodal applications, by enabling voice in a presentation layer with voice markup. X+V provides voice-based interaction in small and mobile devices using both voice and visual elements. X+V is composed of three main standards: XHTML, VoiceXML, and XML Events. Given that the Web application environment is event-driven, X+V incorporates the Document Object Model (DOM) eventing framework used in the XML Events standard. Using this framework, X+V defines the familiar event types from HTML to create the correlation between visual and voice markup.

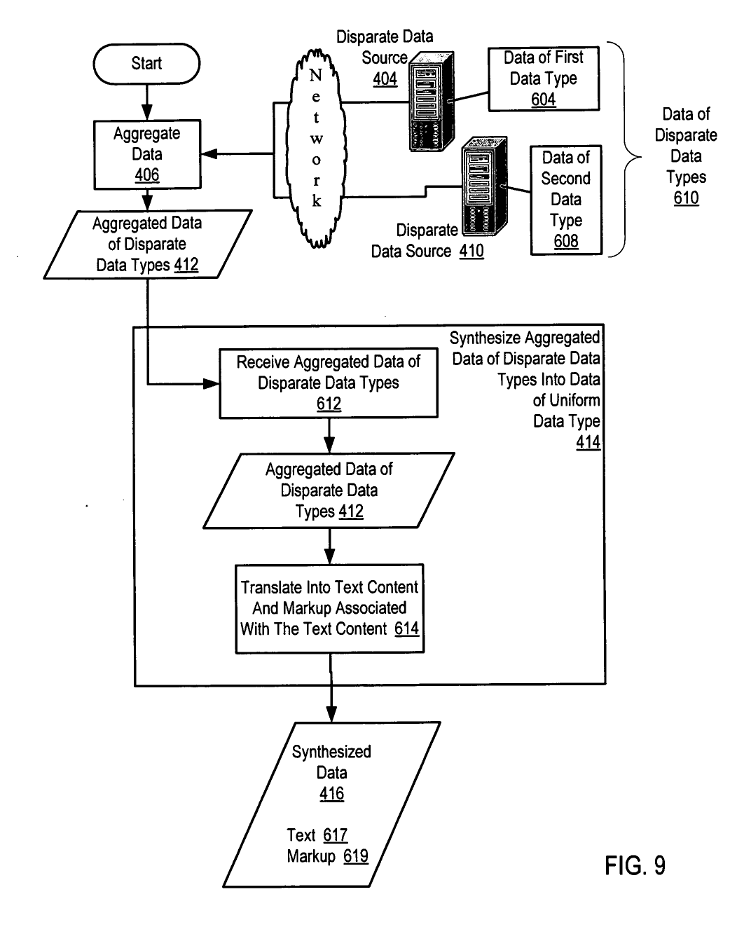

Synthesizing (414) the aggregated data of disparate data types (412) into data of a uniform data type may be carried out by receiving aggregated data of disparate data types and translating each of the aggregated data of disparate data types into text content and markup associated with the text content as discussed in more detail with reference to FIG. 9. In the method of FIG. 4, synthesizing the aggregated data of disparate data types (412) into data of a uniform data type may be carried out by translating the aggregated data into X+V, or any other markup language as will occur to those of skill in the art.

The method for data management and data rendering of FIG. 4 also includes identifying (418) an action in dependence upon the synthesized data (416). An action is a set of computer instructions that when executed carry out a predefined task. The action may be executed in dependence upon the synthesized data immediately or at some defined later time. Identifying (418) an action in dependence upon the synthesized data (416) may be carried out by receiving a user instruction, selecting synthesized data in response to the user instruction, and selecting an action in dependence upon the user instruction and the selected data.

A user instruction is an event received in response to an act by a user. Exemplary user instructions include receiving events as a result of a user entering a combination of keystrokes using a keyboard or keypad, receiving speech from a user, receiving an event as a result of clicking on icons on a visual display by using a mouse, receiving an event as a result of a user pressing an icon on a touchpad, or other user instructions as will occur to those of skill in the art. Receiving a user instruction may be carried out by receiving speech from a user, converting the speech to text, and determining in dependence upon the text and a grammar the user instruction. Alternatively, receiving a user instruction may be carried out by receiving speech from a user and determining the user instruction in dependence upon the speech and a grammar.

The method of FIG. 4 also includes executing (424) the identified action (420). Executing (424) the identified action (420) may be carried out by calling a member method in an action object identified in dependence upon the synthesized data, executing computer program instructions carrying out the identified action, as well as other ways of executing an identified action as will occur to those of skill in the art. Executing (424) the identified action (420) may also include determining the availability of a communications network required to carry out the action and executing the action only if the communications network is available and postponing executing the action if the communications network connection is not available. Postponing executing the action if the communications network connection is not available may include enqueuing identified actions into an action queue, storing the actions until a communications network is available, and then executing the identified actions. Another way that waiting to execute the identified action (420) may be carried out is by inserting an entry delineating the action into a container, and later processing the container. A container could be any data structure suitable for storing an entry delineating an action, such as, for example, an XML file.

Executing (424) the identified action (420) may include modifying the content of data of one of the disparate data sources. Consider for example, an action called deleteOldEmail() that when executed deletes not only synthesized data translated from email, but also deletes the original source email stored on an email server coupled for data communications with a data management and data rendering module operating according to the present invention.

The method of FIG. 4 also includes channelizing (422) the synthesized data (416). A channel is a logical aggregation of data content for presentation to a user. Channelizing (422) the synthesized data (416) may be carried out by identifying attributes of the synthesized data, characterizing the attributes of the synthesized data, and assigning the data to a predetermined channel in dependence upon the characterized attributes and channel assignment rules. Channelizing the synthesized data advantageously provides a vehicle for presenting related content to a user. Examples of such channelized data may be a ‘work channel’ that provides a channel of work related content, an ‘entertainment channel’ that provides a channel of entertainment content an so on as will occur to those of skill in the art.

The method of FIG. 4 may also include presenting (426) the synthesized data (416) to a user through one or more channels. One way presenting (426) the synthesized data (416) to a user through one or more channels may be carried out is by presenting summaries or headings of available channels. The content presented through those channels can be accessed via this presentation in order to access the synthesized data (416). Another way presenting (426) the synthesized data (416) to a user through one or more channels may be carried out by displaying or playing the synthesized data (416) contained in the channel. Text might be displayed visually, or it could be translated into a simulated voice and played for the user.

### Aggregating Data of Disparate Data Types

For further explanation, FIG. 5 sets forth a flow chart illustrating an exemplary method for aggregating data of disparate data types from disparate data sources according to embodiments of the present invention. In the method of FIG. 5, aggregating (406) data of disparate data types (402, 408) from disparate data sources (404, 522) includes receiving (506), from an aggregation process (502), a request for data (508). A request for data may be implemented as a message, from the aggregation process, to a dispatcher instructing the dispatcher to initiate retrieving the requested data and returning the requested data to the aggregation process.

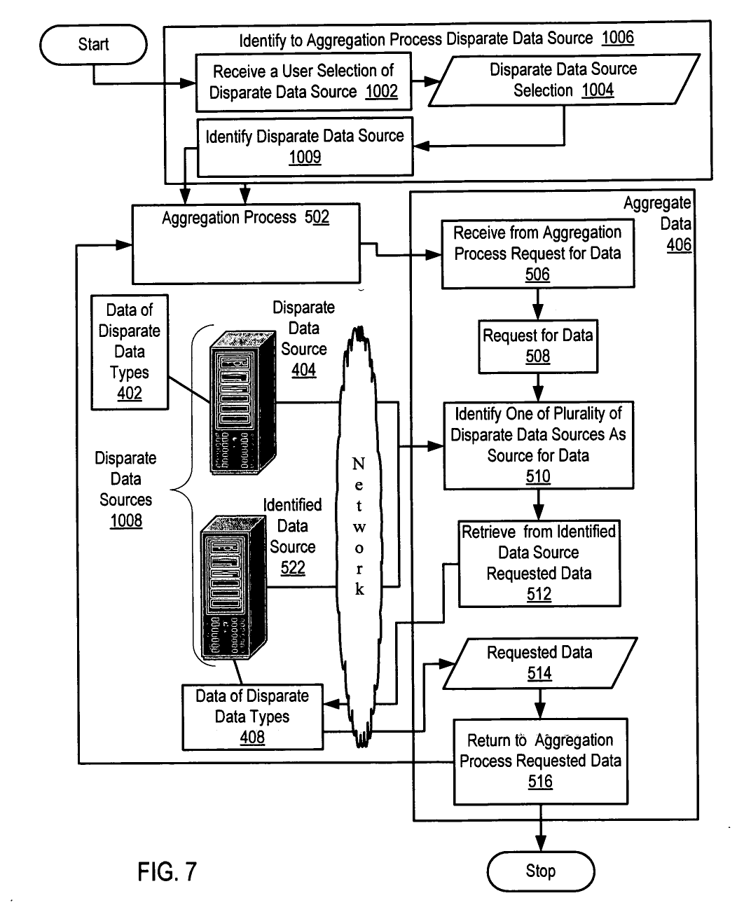

In the method of FIG. 5, aggregating (406) data of disparate data types (402, 408) from disparate data sources (404, 522) also includes identifying (510), in response to the request for data (508), one of a plurality of disparate data sources (404, 522) as a source for the data. Identifying (510), in response to the request for data (508), one of a plurality of disparate data sources (404, 522) as a source for the data may be carried in a number of ways. One way of identifying (510) one of a plurality of disparate data sources (404, 522) as a source for the data may be carried out by receiving, from a user, an identification of the disparate data source; and identifying, to the aggregation process, the disparate data source in dependence upon the identification as discussed in more detail below with reference to FIG. 7.

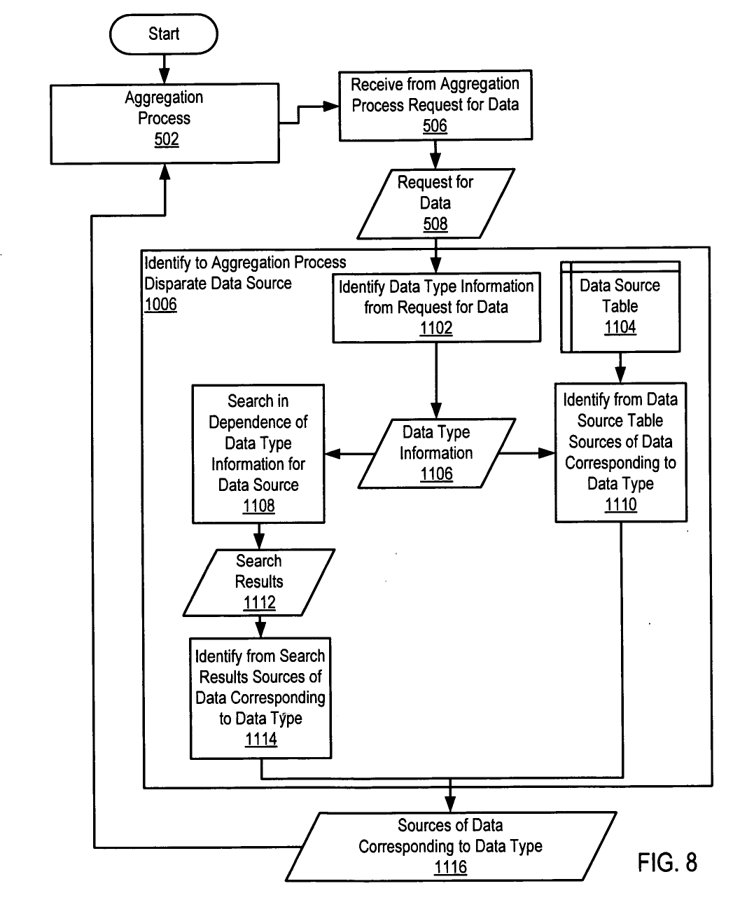

Another way of identifying, to the aggregation process (502), disparate data sources is carried out by identifying, from the request for data, data type information and identifying from the data source table sources of data that correspond to the data type as discussed in more detail below with reference to FIG. 8. Still another way of identifying one of a plurality of data sources is carried out by identifying, from the request for data, data type information; searching, in dependence upon the data type information, for a data source; and identifying from the search results returned in the data source search, sources of data corresponding to the data type also discussed below in more detail with reference to FIG. 8.

The three methods for identifying one of a plurality of data sources described in this specification are for explanation and not for limitation. In fact, there are many ways of identifying one of a plurality of data sources and all such ways are well within the scope of the present invention.

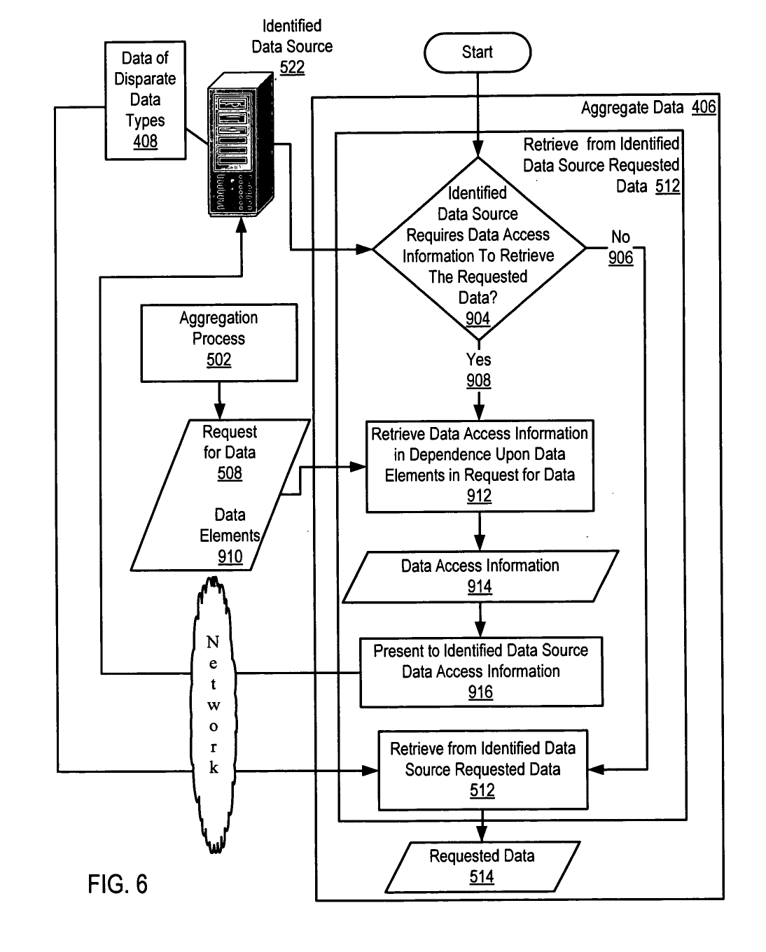

The method for aggregating (406) data of FIG. 5 includes retrieving (512), from the identified data source (522), the requested data (514). Retrieving (512), from the identified data source (522), the requested data (514) includes determining whether the identified data source requires data access information to retrieve the requested data; retrieving, in dependence upon data elements contained in the request for data, the data access information if the identified data source requires data access information to retrieve the requested data; and presenting the data access information to the identified data source as discussed in more detail below with reference to FIG. 6. Retrieving (512) the requested data according the method of FIG. 5 may be carried out by retrieving the data from memory locally, downloading the data from a network location, or any other way of retrieving the requested data that will occur to those of skill in the art. As discussed above, retrieving (512), from the identified data source (522), the requested data (514) may be carried out by a data-source-specific plug-in designed to retrieve data from a particular data source or a particular type of data source.

In the method of FIG. 5, aggregating (406) data of disparate data types (402, 408) from disparate data sources (404, 522) also includes returning (516), to the aggregation process (502), the requested data (514). Returning (516), to the aggregation process (502), the requested data (514) returning the requested data to the aggregation process in a message, storing the data locally and returning a pointer pointing to the location of the stored data to the aggregation process, or any other way of returning the requested data that will occur to those of skill in the art.

As discussed above with reference to FIG. 5, aggregating (406) data of FIG. 5 includes retrieving, from the identified data source, the requested data. For further explanation, therefore, FIG. 6 sets forth a flow chart illustrating an exemplary method for retrieving (512), from the identified data source (522), the requested data (514) according to embodiments of the present invention. In the method of FIG. 6, retrieving (512), from the identified data source (522), the requested data (514) includes determining (904) whether the identified data source (522) requires data access information (914) to retrieve the requested data (514). As discussed above in reference to FIG. 5, data access information is information which is required to access some types of data from some of the disparate sources of data. Exemplary data access information includes account names, account numbers, passwords, or any other data access information that will occur to those of skill in the art.

Determining (904) whether the identified data source (522) requires data access information (914) to retrieve the requested data (514) may be carried out by attempting to retrieve data from the identified data source and receiving from the data source a prompt for data access information required to retrieve the data. Alternatively, instead of receiving a prompt from the data source each time data is retrieved from the data source, determining (904) whether the identified data source (522) requires data access information (914) to retrieve the requested data (514) may be carried out once by, for example a user, and provided to a dispatcher such that the required data access information may be provided to a data source with any request for data without prompt. Such data access information may be stored in, for example, a data source table identifying any corresponding data access information needed to access data from the identified data source.

In the method of FIG. 6, retrieving (512), from the identified data source (522), the requested data (514) also includes retrieving (912), in dependence upon data elements (910) contained in the request for data (508), the data access information (914), if the identified data source requires data access information to retrieve the requested data (908). Data elements (910) contained in the request for data (508) are typically values of attributes of the request for data (508). Such values may include values identifying the type of data to be accessed, values identifying the location of the disparate data source for the requested data, or any other values of attributes of the request for data.

Such data elements (910) contained in the request for data (508) are useful in retrieving data access information required to retrieve data from the disparate data source. Data access information needed to access data sources for a user may be usefully stored in a record associated with the user indexed by the data elements found in all requests for data from the data source. Retrieving (912), in dependence upon data elements (910) contained in the request for data (508), the data access information (914) according to FIG. 6 may therefore be carried out by retrieving, from a database in dependence upon one or more data elements in the request, a record containing the data access information and extracting from the record the data access information. Such data access information may be provided to the data source to retrieve the data.

Retrieving (912), in dependence upon data elements (910) contained in the request for data (508), the data access information (914), if the identified data source requires data access information (914) to retrieve the requested data (908), may be carried out by identifying data elements (910) contained in the request for data (508), parsing the data elements to identify data access information (914) needed to retrieve the requested data (908), identifying in a data access table the correct data access information, and retrieving the data access information (914).

The exemplary method of FIG. 6 for retrieving (512), from the identified data source (522), the requested data (514) also includes presenting (916) the data access information (914) to the identified data source (522). Presenting (916) the data access information (914) to the identified data source (522) according to the method of FIG. 6 may be carried out by providing in the request the data access information as parameters to the request or providing the data access information in response to a prompt for such data access information by a data source. That is, presenting (916) the data access information (914) to the identified data source (522) may be carried out by a selected data source specific plug-in of a dispatcher that provides data access information (914) for the identified data source (522) in response to a prompt for such data access information. Alternatively, presenting (916) the data access information (914) to the identified data source (522) may be carried out by a selected data source specific plug-in of a dispatcher that passes as parameters to request the data access information (914) for the identified data source (522) without prompt.

As discussed above, aggregating data of disparate data types from disparate data sources according to embodiments of the present invention typically includes identifying, to the aggregation process, disparate data sources. That is, prior to requesting data from a particular data source, that data source typically is identified to an aggregation process. For further explanation, therefore, FIG. 7 sets forth a flow chart illustrating an exemplary method for aggregating data of disparate data types (404, 522) from disparate data sources (404, 522) according to the present invention that includes identifying (1006), to the aggregation process (502), disparate data sources (1008). In the method of FIG. 7, identifying (1006), to the aggregation process (502), disparate data sources (1008) includes receiving (1002), from a user, a selection (1004) of the disparate data source. A user is typically a person using a data management a data rendering system to manage and render data of disparate data types (402, 408) from disparate data sources (1008) according to the present invention. Receiving (1002), from a user, a selection (1004) of the disparate data source may be carried out by receiving, through a user interface of a data management and data rendering application, from the user a user instruction containing a selection of the disparate data source and identifying (1009), to the aggregation process (502), the disparate data source (404, 522) in dependence upon the selection (1004). A user instruction is an event received in response to an act by a user such as an event created as a result of a user entering a combination of keystrokes, using a keyboard or keypad, receiving speech from a user, receiving an clicking on icons on a visual display by using a mouse, pressing an icon on a touchpad, or other use act as will occur to those of skill in the art. A user interface in a data management and data rendering application may usefully provide a vehicle for receiving user selections of particular disparate data sources.

In the example of FIG. 7, identifying disparate data sources to an aggregation process is carried out by a user. Identifying disparate data sources may also be carried out by processes that require limited or no user interaction. For further explanation, FIG. 8 sets forth a flow chart illustrating an exemplary method for aggregating data of disparate data types from disparate data sources requiring little or no user action that includes identifying (1006), to the aggregation process (502), disparate data sources (1008) includes identifying (1102), from a request for data (508), data type information (1106). Disparate data types identify data of different kind and form. That is, disparate data types are data of different kinds. The distinctions in data that define the disparate data types may include a difference in data structure, file format, protocol in which the data is transmitted, and other distinctions as will occur to those of skill in the art. Data type information (1106) is information representing these distinctions in data that define the disparate data types.

Identifying (1102), from the request for data (508), data type information (1106) according to the method of FIG. 8 may be carried out by extracting a data type code from the request for data. Alternatively, identifying (1102), from the request for data (508), data type information (1106) may be carried out by inferring the data type of the data being requested from the request itself, such as by extracting data elements from the request and inferring from those data elements the data type of the requested data, or in other ways as will occur to those of skill in the art.

In the method for aggregating of FIG. 8, identifying (1006), to the aggregation process (502), disparate data sources also includes identifying (1110), from a data source table (1104), sources of data corresponding to the data type (1116). A data source table is a table containing identification of disparate data sources indexed by the data type of the data retrieved from those disparate data sources. Identifying (1110), from a data source table (1104), sources of data corresponding to the data type (116) may be carried out by performing a lookup on the data source table in dependence upon the identified data type.

In some cases no such data source may be found for the data type or no such data source table is available for identifying a disparate data source. In the method of FIG. 8 therefore includes an alternative method for identifying (1006), to the aggregation process (502), disparate data sources that includes searching (1108), in dependence upon the data type information (1106), for a data source and identifying (1114), from search results (1112) returned in the data source search, sources of data corresponding to the data type (1116). Searching (1108), in dependence upon the data type information (1106), for a data source may be carried out by creating a search engine query in dependence upon the data type information and querying the search engine with the created query. Querying a search engine may be carried out through the use of URL encoded data passed to a search engine through, for example, an HTTP GET or HTTP POST function. URL encoded data is data packaged in a URL for data communications, in this case, passing a query to a search engine. In the case of HTTP communications, the HTTP GET and POST functions are often used to transmit URL encoded data. In this context, it is useful to remember that URLs do more than merely request file transfers. URLs identify resources on servers. Such resources may be files having filenames, but the resources identified by URLs also include, for example, queries to databases. Results of such queries do not necessarily reside in files, but they are nevertheless data resources identified by URLs and identified by a search engine and query data that produce such resources. An example of URL encoded data is:
http://www.example.com/search?field1=value1&field2=value2

This example of URL encoded data representing a query that is submitted over the web to a search engine. More specifically, the example above is a URL bearing encoded data representing a query to a search engine and the query is the string “field1=value1&field2=value2.” The exemplary encoding method is to string field names and field values separated by ‘&’ and “=” and designate the encoding as a query by including “search” in the URL. The exemplary URL encoded search query is for explanation and not for limitation. In fact, different search engines may use different syntax in representing a query in a data encoded URL and therefore the particular syntax of the data encoding may vary according to the particular search engine queried.

Identifying (1114), from search results (1112) returned in the data source search, sources of data corresponding to the data type (1116) may be carried out by retrieving URLs to data sources from hyperlinks in a search results page returned by the search engine.

### Synthesizing Aggregated Data

As discussed above, data management and data rendering for disparate data types includes synthesizing aggregated data of disparate data types into data of a uniform data type. For further explanation, FIG. 9 sets forth a flow chart illustrating a method for synthesizing (414) aggregated data of disparate data types (412) into data of a uniform data type. As discussed above, aggregated data of disparate data types (412) is the accumulation, in a single location, of data of disparate types. This location of the aggregated data may be either physical, such-as, for example, on a single computer containing aggregated data, or logical, such as, for example, a single interface providing access to the aggregated data. Also as discussed above, disparate data types are data of different kind and form. That is, disparate data types are data of different kinds. Data of a uniform data type is data having been created or translated into a format of predetermined type. That is, uniform data types are data of a single kind that may be rendered on a device capable of rendering data of the uniform data type. Synthesizing (414) aggregated data of disparate data types (412) into data of a uniform data type advantageously makes the content of the disparate data capable of being rendered on a single device.

In the method of FIG. 9, synthesizing (414) aggregated data of disparate data types (412) into data of a uniform data type includes receiving (612) aggregated data of disparate data types. Receiving (612) aggregated data of disparate data types (412) may be carried out by receiving, from aggregation process having accumulated the disparate data, data of disparate data types from disparate sources for synthesizing into a uniform data type.

In the method for synthesizing of FIG. 9, synthesizing (414) the aggregated data (406) of disparate data types (610) into data of a uniform data type also includes translating (614) each of the aggregated data of disparate data types (610) into text (617) content and markup (619) associated with the text content. Translating (614) each of the aggregated data of disparate data types (610) into text (617) content and markup (619) associated with the text content according to the method of FIG. 9 includes representing in text and markup the content of the aggregated data such that a browser capable of rendering the text and markup may render from the translated data the same content contained in the aggregated data prior to being synthesized.

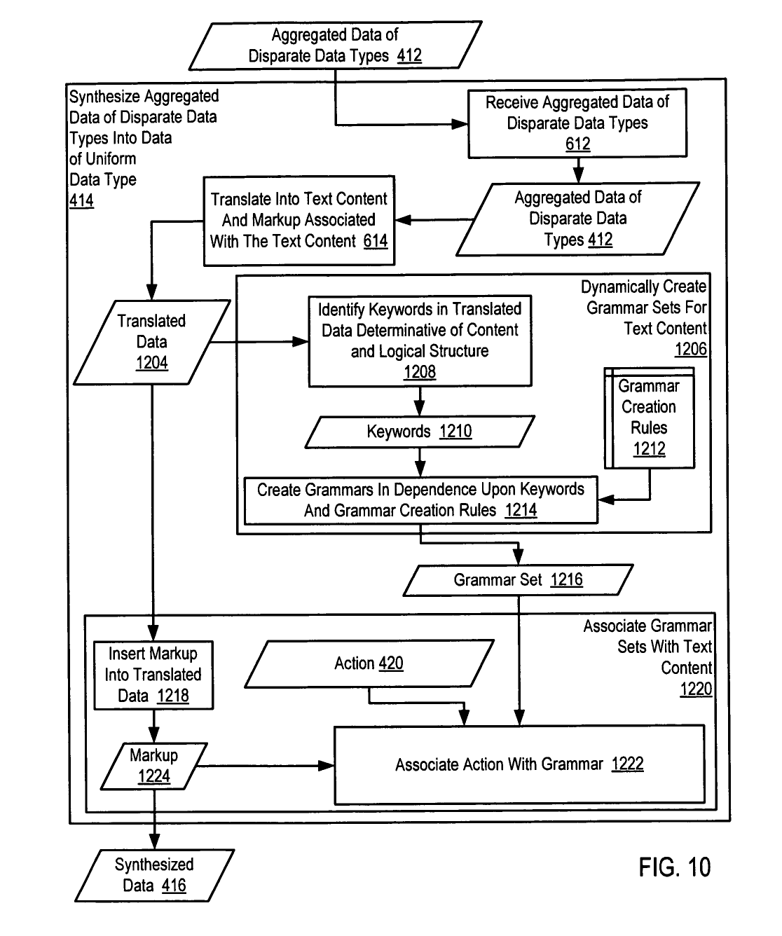

In the method of FIG. 9, translating (614) each of the aggregated data of disparate data types (610) into text (617) content and markup (619) may be carried out by creating an X+V document for the aggregated data including text, markup, grammars and so on as will be discussed in more detail below with reference to FIG. 10. The use of X+V is for explanation and not for limitation. In fact, other markup languages may be useful in synthesizing (414) the aggregated data (406) of disparate data types (610) into data of a uniform data type according to the present invention such as XML, VXML, or any other markup language as will occur to those of skill in the art.

Translating (614) each of the aggregated data of disparate data types (610) into text (617) content and markup (619) such that a browser capable of rendering the text and markup may render from the translated data the same content contained in the aggregated data prior to being synthesized may include augmenting the content in translation in some way. That is, translating aggregated data types into text and markup may result in some modification to the content of the data or may result in deletion of some content that cannot be accurately translated. The quantity of such modification and deletion will vary according to the type of data being translated as well as other factors as will occur to those of skill in the art.

Translating (614) each of the aggregated data of disparate data types (610) into text (617) content and markup (619) associated with the text content may be carried out by translating the aggregated data into text and markup and parsing the translated content dependent upon data type. Parsing the translated content dependent upon data type means identifying the structure of the translated content and identifying aspects of the content itself, and creating markup (619) representing the identified structure and content.

Consider for further explanation the following markup language depiction of a snippet of audio clip describing the president.

```
<head> original file type= ‘MP3’ keyword = ‘president’ number = ‘50’,
keyword = ‘air force’ number = ‘1’ keyword = ‘white house’
number =’2’ >
</head>
    <content>
        Some content about the president
    </content>
```

In the example above an MP3 audio file is translated into text and markup. The header in the example above identifies the translated data as having been translated from an MP3 audio file. The exemplary header also includes keywords included in the content of the translated document and the frequency with which those keywords appear. The exemplary translated data also includes content identified as ‘some content about the president.’

As discussed above, one useful uniform data type for synthesized data is XHTML plus Voice. XHTML plus Voice (‘X+V’) is a Web markup language for developing multimodal applications, by enabling voice with voice markup. X+V provides voice-based interaction in devices using both voice and visual elements. Voice enabling the synthesized data for data management and data rendering according to embodiments of the present invention is typically carried out by creating grammar sets for the text content of the synthesized data. A grammar is a set of words that may be spoken, patterns in which those words may be spoken, or other language elements that define the speech recognized by a speech recognition engine. Such speech recognition engines are useful in a data management and rendering engine to provide users with voice navigation of and voice interaction with synthesized data.

For further explanation, therefore, FIG. 10 sets forth a flow chart illustrating a method for synthesizing (414) aggregated data of disparate data types (412) into data of a uniform data type that includes dynamically creating grammar sets for the text content of synthesized data for voice interaction with a user. Synthesizing (414) aggregated data of disparate data types (412) into data of a uniform data type according to the method of FIG. 10 includes receiving (612) aggregated data of disparate data types (412). As discussed above, receiving (612) aggregated data of disparate data types (412) may be carried out by receiving, from aggregation process having accumulated the disparate data, data of disparate data types from disparate sources for synthesizing into a uniform data type.

The method of FIG. 10 for synthesizing (414) aggregated data of disparate data types (412) into data of a uniform data type also includes translating (614) each of the aggregated data of disparate data types (412) into translated data (1204) comprising text content and markup associated with the text content. As discussed above, translating (614) each of the aggregated data of disparate data types (412) into text content and markup associated with the text content includes representing in text and markup the content of the aggregated data such that a browser capable of rendering the text and markup may render from the translated data the same content contained in the aggregated data prior to being synthesized. In some cases, translating (614) the aggregated data of disparate data types (412) into text content and markup such that a browser capable of rendering the text and markup may include augmenting or deleting some of the content being translated in some way as will occur to those of skill in the art.

In the method of FIG. 10, translating (1202) each of the aggregated data of disparate data types (412) into translated data (1204) comprising text content and markup may be carried out by creating an X+V document for the synthesized data including text, markup, grammars and so on as will be discussed in more detail below. The use of X+V is for explanation and not for limitation. In fact, other markup languages may be useful in translating (614) each of the aggregated data of disparate data types (412) into translated data (1204) comprising text content and markup associated with the text content as will occur to those of skill in the art.

The method of FIG. 10 for synthesizing (414) aggregated data of disparate data types (412) into data of a uniform data type may include dynamically creating (1206) grammar sets (1216) for the text content. As discussed above, a grammar is a set of words that may be spoken, patterns in which those words may be spoken, or other language elements that define the speech recognized by a speech recognition engine

In the method of FIG. 10, dynamically creating (1206) grammar sets (1216) for the text content also includes identifying (1208) keywords (1210) in the translated data (1204) determinative of content or logical structure and including the identified keywords in a grammar associated with the translated data. Keywords determinative of content are words and phrases defining the topics of the content of the data and the information presented the content of the data. Keywords determinative of logical structure are keywords that suggest the form in which information of the content of the data is presented. Examples of logical structure include typographic structure, hierarchical structure, relational structure, and other logical structures as will occur to those of skill in the art.

Identifying (1208) keywords (1210) in the translated data (1204) determinative of content may be carried out by searching the translated text for words that occur in a text more often than some predefined threshold. The frequency of the word exceeding the threshold indicates that the word is related to the content of the translated text because the predetermined threshold is established as a frequency of use not expected to occur by chance alone. Alternatively, a threshold may also be established as a function rather than a static value. In such cases, the threshold value for frequency of a word in the translated text may be established dynamically by use of a statistical test which compares the word frequencies in the translated text with expected frequencies derived statistically from a much larger corpus. Such a larger corpus acts as a reference for general language use.

Identifying (1208) keywords (1210) in the translated data (1204) determinative of logical structure may be carried out by searching the translated data for predefined words determinative of structure. Examples of such words determinative of logical structure include ‘introduction,’ ‘table of contents,’ ‘chapter,’ ‘stanza,’ ‘index,’ and many others as will occur to those of skill in the art.

In the method of FIG. 10, dynamically creating (1206) grammar sets (1216) for the text content also includes creating (1214) grammars in dependence upon the identified keywords (1210) and grammar creation rules (1212). Grammar creation rules are a pre-defined set of instructions and grammar form for the production of grammars. Creating (1214) grammars in dependence upon the identified keywords (1210) and grammar creation rules (1212) may be carried out by use of scripting frameworks such as JavaServer Pages, Active Server Pages, PHP, Perl, XML from translated data. Such dynamically created grammars may be stored externally and referenced, in for example, X+V the <grammar src=″″/> tag that is used to reference external grammars.

The method of FIG. 10 for synthesizing (414) aggregated data of disparate data types (412) into data of a uniform data type includes associating (1220) the grammar sets (1216) with the text content. Associating (1220) the grammar sets (1216) with the text content includes inserting (1218) markup (1224) defining the created grammar into the translated data (1204). Inserting (1218) markup in the translated data (1204) may be carried out by creating markup defining the dynamically created grammar inserting the created markup into the translated document.

The method of FIG. 10 also includes associating (1222) an action (420) with the grammar. As discussed above, an action is a set of computer instructions that when executed carry out a predefined task. Associating (1222) an action (420) with the grammar thereby provides voice initiation of the action such that the associated action is invoked in response to the recognition of one or more words or phrases of the grammar.

### Identifying an Action in Dependence Upon the Synthesized Data

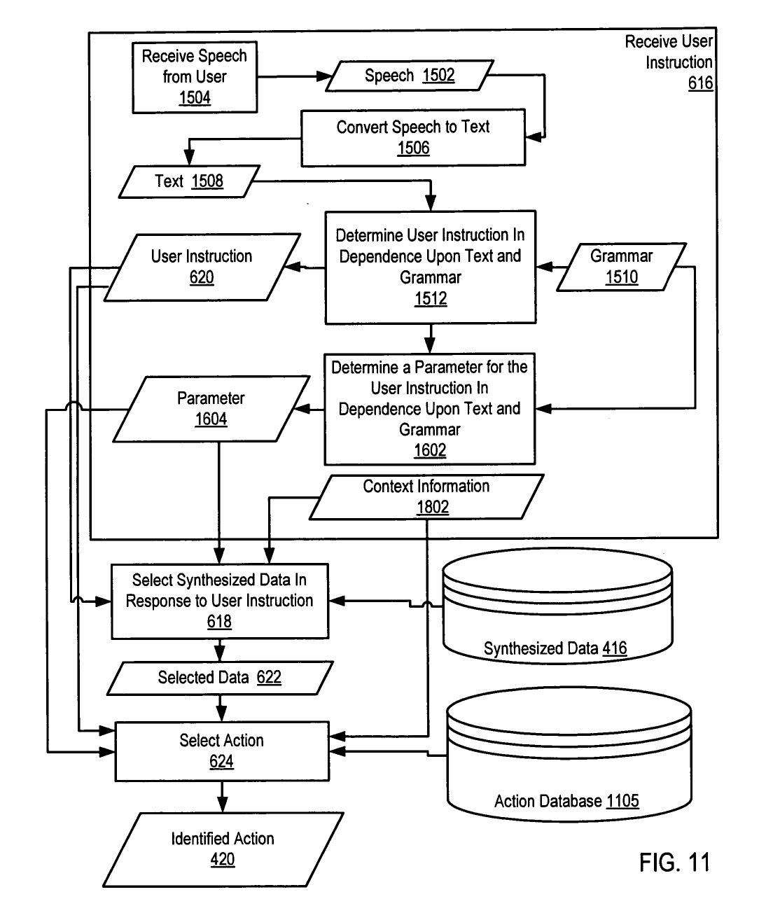

As discussed above, data management and data rendering for disparate data types includes identifying an action in dependence upon the synthesized data. For further explanation, FIG. 11 sets forth a flow chart illustrating an exemplary method for identifying an action in dependence upon the synthesized data (416) including receiving (616) a user instruction (620) and identifying an action in dependence upon the synthesized data (416) and the user instruction. In the method of FIG. 11, identifying an action may be carried out by retrieving an action ID from an action list. In the method of FIG. 11, retrieving an action ID from an action list includes retrieving from a list the identification of the action (the ‘action ID’) to be executed in dependence upon the user instruction and the synthesized data. The action list can be implemented, for example, as a Java list container, as a table in random access memory, as a SQL database table with storage on a hard drive or CD ROM, and in other ways as will occur to those of skill in the art. As mentioned above, the actions themselves comprise software, and so can be implemented as concrete action classes embodied, for example, in a Java package imported into a data management and data rendering module at compile time and therefore always available during run time.

In the method of FIG. 11, receiving (616) a user instruction (620) includes receiving (1504) speech (1502) from a user, converting (1506) the speech (1502) to text (1508); determining (1512) in dependence upon the text (1508) and a grammar (1510) the user instruction (620) and determining (1602) in dependence upon the text (1508) and a grammar (1510) a parameter (1604) for the user instruction (620). As discussed above with reference to FIG. 4, a user instruction is an event received in response to an act by a user. A parameter to a user instruction is additional data further defining the instruction. For example, a user instruction for ‘delete email’ may include the parameter ‘Aug. 11, 2005’ defining that the email of Aug 11, 2005 is the synthesized data upon which the action invoked by the user instruction is to be performed. Receiving (1504) speech (1502) from a user, converting (1506) the speech (1502) to text (1508); determining (1512) in dependence upon the text (1508) and a grammar (1510) the user instruction (620); and determining (1602) in dependence upon the text (1508) and a grammar (1510) a parameter (1604) for the user instruction (620) may be carried out by a speech recognition engine incorporated into a data management and data rendering module according to the present invention.

Identifying an action in dependence upon the synthesized data (416) according to the method of FIG. 11 also includes selecting (618) synthesized data (416) in response to the user instruction (620). Selecting (618) synthesized data (416) in response to the user instruction (620) may be carried out by selecting synthesized data identified by the user instruction (620). Selecting (618) synthesized data (416) may also be carried out by selecting the synthesized data (416) in dependence upon a parameter (1604) of the user instruction (620).

Selecting (618) synthesized data (416) in response to the user instruction (620) may be carried out by selecting synthesized data context information (1802). Context information is data describing the context in which the user instruction is received such as, for example, state information of currently displayed synthesized data, time of day, day of week, system configuration, properties of the synthesized data, or other context information as will occur to those of skill in the art. Context information may be usefully used instead or in conjunction with parameters to the user instruction identified in the speech. For example, the context information identifying that synthesized data translated from an email document is currently being displayed may be used to supplement the speech user instruction ‘delete email’ to identify upon which synthesized data to perform the action for deleting an email.

Identifying an action in dependence upon the synthesized data (416) according to the method of FIG. 11 also includes selecting (624) an action (420) in dependence upon the user instruction (620) and the selected data (622). Selecting (624) an action (420) in dependence upon the user instruction (620) and the selected data (622) may be carried out by selecting an action identified by the user instruction. Selecting (624) an action (420) may also be carried out by selecting the action (420) in dependence upon a parameter (1604) of the user instructions (620) and by selecting the action (420) in dependence upon a context information (1802). In the example of FIG. 11, selecting (624) an action (420) is carried out by retrieving an action from an action database (1105) in dependence upon one or more a user instructions, parameters, or context information.

Executing the identified action may be carried out by use of a switch() statement in an action agent of a data management and data rendering module. Such a switch() statement can be operated in dependence upon the action ID and implemented, for example, as illustrated by the following segment of pseudocode:

```
switch (actionID) {
    Case 1: actionNumber1.take_action( ); break;
    Case 2: actionNumber2.take_action( ); break;
    Case 3: actionNumber3.take_action( ); break;
    Case 4: actionNumber4.take_action( ); break;
    Case 5: actionNumber5.take_action( ); break;
    // and so on
} // end switch( )
```

The exemplary switch statement selects an action to be performed on synthesized data for execution depending on the action ID. The tasks administered by the switch() in this example are concrete action classes named actionNumber1, actionNumber2, and so on, each having an executable member method named ‘take_action(),’ which carries out the actual work implemented by each action class.

Executing an action may also be carried out in such embodiments by use of a hash table in an action agent of a data management and data rendering module. Such a hash table can store references to action object keyed by action ID, as shown in the following pseudocode example. This example begins by an action service's creating a hashtable of actions, references to objects of concrete action classes associated with a user instruction. In many embodiments it is an action service that creates such a hashtable, fills it with references to action objects pertinent to a particular user instruction, and returns a reference to the hashtable to a calling action agent.

Hashtable ActionHashTable = new Hashtable( );
ActionHashTable.put(“1”, new Action1( ));
ActionHashTable.put(“2”, new Action2( ));
ActionHashTable.put(“3”, new Action3( ));

Executing a particular action then can be carried out according to the following pseudocode:

Action anAction = (Action) ActionHashTable.get(“2”);
if (anAction != null) anAction.take_action( );

Executing an action may also be carried out by use of list. Lists often function similarly to hashtables. Executing a particular action, for example, can be carried out according to the following pseudocode:

List ActionList = new List( );
ActionList.add(1, new Action1( ));
ActionList.add(2, new Action2( ));
ActionList.add(3, new Action3( ));

Executing a particular action then can be carried out according to the following pseudocode:

Action anAction = (Action) ActionList.get(2);
if (anAction != null) anAction.take_action( );

The three examples above use switch statements, hash tables, and list objects to explain executing actions according to embodiments of the present invention. The use of switch statements, hash tables, and list objects in these examples are for explanation, not for limitation. In fact, there are many ways of executing actions according to embodiments of the present invention, as will occur to those of skill in the art, and all such ways are well within the scope of the present invention.

For further explanation of identifying an action in dependence upon the synthesized data consider the following example of user instruction that identifies an action, a parameter for the action, and the synthesized data upon which to perform the action. A user is currently viewing synthesized data translated from email and issues the following speech instruction: “Delete email dated Aug. 15, 2005.” In the current example, identifying an action in dependence upon the synthesized data is carried out by selecting an action to delete and synthesized data in dependence upon the user instruction, by identifying a parameter for the delete email action identifying that only one email is to be deleted, and by selecting synthesized data translated from the email of Aug. 15, 2005 in response to the user instruction.

For further explanation of identifying an action in dependence upon the synthesized data consider the following example of user instruction that does not specifically identify the synthesized data upon which to perform an action. A user is currently viewing synthesized data translated from a series of emails and issues the following speech instruction: “Delete current email.” In the current example, identifying an action in dependence upon the synthesized data is carried out by selecting an action to delete synthesized data in dependence upon the user instruction. Selecting synthesized data upon which to perform the action, however, in this example is carried out in dependence upon the following data selection rule that makes use of context information.

```
If synthesized data = displayed;
    Then synthesized data = ‘current’.
If synthesized includes = email type code;
    Then synthesized data = email.
```

The exemplary data selection rule above identifies that if synthesized data is displayed then the displayed synthesized data is ‘current’ and if the synthesized data includes an email type code then the synthesized data is email. Context information is used to identify currently displayed synthesized data translated from an email and bearing an email type code. Applying the data selection rule to the exemplary user instruction “delete current email” therefore results in deleting currently displayed synthesized data having an email type code.

### Channelizing The Synthesized Data

As discussed above, data management and data rendering for disparate data types often includes channelizing the synthesized data. Channelizing the synthesized data (416) advantageously results in the separation of synthesized data into logical channels. A channel implemented as a logical accumulation of synthesized data sharing common attributes having similar characteristics. Examples of such channels are ‘entertainment channel’ for synthesized data relating to entertainment, ‘work channel’ for synthesized data relating to work, ‘family channel’ for synthesized data relating to a user's family and so on.

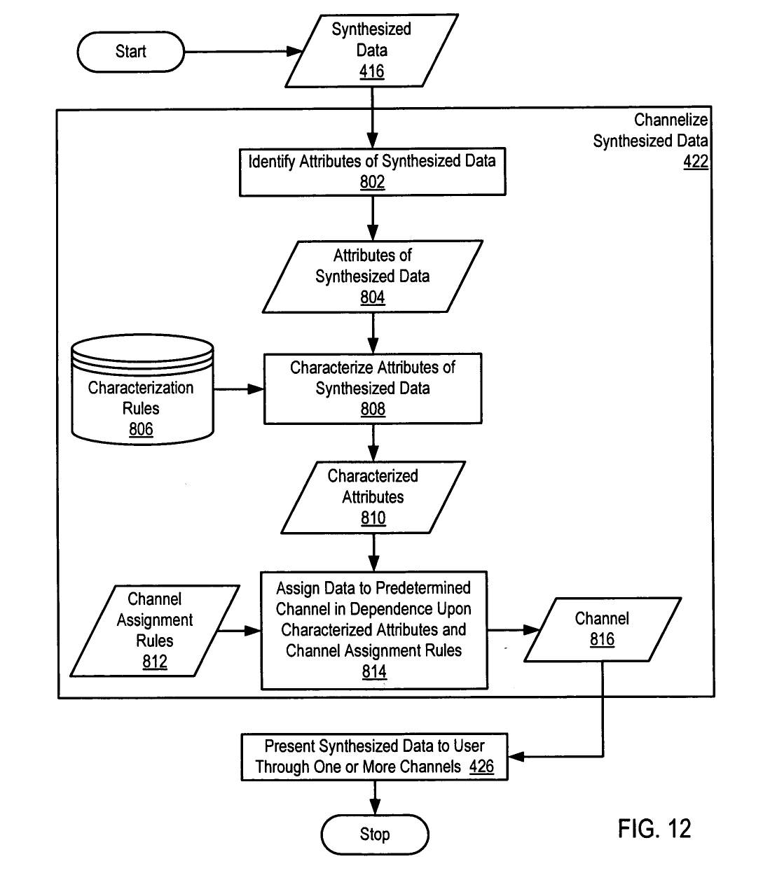

For further explanation, therefore, FIG. 12 sets forth a flow chart illustrating an exemplary method for channelizing (422) the synthesized data (416) according to the present invention, which includes identifying (802) attributes of the synthesized data (804). Attributes of synthesized data (804) are aspects of the data which may be used to characterize the synthesized data (416). Exemplary attributes (804) include the type of the data, metadata present in the data, logical structure of the data, presence of particular keywords in the content of the data, the source of the data, the application that created the data, URL of the source, author, subject, date created, and so on. Identifying (802) attributes of the synthesized data (804) may be carried out by comparing contents of the synthesized data (804) with a list of predefined attributes. Another way that identifying (802) attributes of the synthesized data (804) may be carried out by comparing metadata associated with the synthesized data (804) with a list of predefined attributes.

The method of FIG. 12 for channelizing (422) the synthesized data (416) also includes characterizing (808) the attributes of the synthesized data (804). Characterizing (808) the attributes of the synthesized data (804) may be carried out by evaluating the identified attributes of the synthesized data. Evaluating the identified attributes of the synthesized data may include applying a characterization rule (806) to an identified attribute. For further explanation consider the following characterization rule:

If synthesized data = email; AND
If email to = “Joe”; AND
If email from = “Bob”;
Then email = ‘work email.’

In the example above, the characterization rule dictates that if synthesized data is an email and if the email was sent to “Joe” and if the email sent from “Bob” then the exemplary email is characterized as a ‘work email.’

Characterizing (808) the attributes of the synthesized data (804) may further be carried out by creating, for each attribute identified, a characteristic tag representing a characterization for the identified attribute. Consider for further explanation the following example of synthesized data translated from an email having inserted within it a characteristic tag.

```
<head >
original message type = ‘email’ to = ‘joe’ from = ‘bob’ re = ‘I will be late
tomorrow’</head>
    <characteristic>
        characteristic = ‘work’
    <characteristic>
    <body>
        Some body content
    </body>
```

In the example above, the synthesized data is translated from an email sent to Joe from ‘Bob’ having a subject line including the text ‘I will be late tomorrow. In the example above <characteristic> tags identify a characteristic field having the value ‘work’ characterizing the email as work related. Characteristic tags aid in channelizing synthesized data by identifying characteristics of the data useful in channelizing the data.

The method of FIG. 12 for channelizing (422) the synthesized data (416) also includes assigning (814) the data to a predetermined channel (816) in dependence upon the characterized attributes (810) and channel assignment rules (812). Channel assignment rules (812) are predetermined instructions for assigning synthesized data (416) into a channel in dependence upon characterized attributes (810). Consider for further explanation the following channel assignment rule:

If synthesized data = ‘email’; and
If Characterization = ‘work related email’
Then channel = ‘work channel.’

In the example above, if the synthesized data is translated from an email and if the email has been characterized as ‘work related email’ then the synthesized data is assigned to a ‘work channel.’

Assigning (814) the data to a predetermined channel (816) may also be carried out in dependence upon user preferences, and other factors as will occur to those of skill in the art. User preferences are a collection of user choices as to configuration, often kept in a data structure isolated from business logic. User preferences provide additional granularity for channelizing synthesized data according to the present invention.

Under some channel assignment rules (812), synthesized data (416) may be assigned to more than one channel (816). That is, the same synthesized data may in fact be applicable to more than one channel. Assigning (814) the data to a predetermined channel (816) may therefore be carried out more than once for a single portion of synthesized data.

The method of FIG. 12 for channelizing (422) the synthesized data (416) may also include presenting (426) the synthesized data (416) to a user through one or more channels (816). One way presenting (426) the synthesized data (416) to a user through one or more channels (816) may be carried out is by presenting summaries or headings of available channels in a user interface allowing a user access to the content of those channels. These channels could be accessed via this presentation in order to access the synthesized data (416). The synthesized data is additionally to the user through the selected channels by displaying or playing the synthesized data (416) contained in the channel.

### Publishing Synthesized RSS Content as an Audio File

As discussed above, in data management and data rendering according to the present invention, actions are often identified and executed in dependence upon synthesized data, such as for example, synthesized RSS data. While synthesized RSS data is useful for data management and data rendering, in many circumstances, reviewing synthesized RSS content with a legacy device, such as a car CD player or a Digital Audio Player, is more convenient than reviewing the synthesized RSS content with a device enabled for data management and data rendering. Data management and data rendering for disparate data types according to the present invention therefore includes publishing synthesized RSS content as an audio file. Playing the audio files containing the published synthesized RSS content on an audio device results in speech presentation of the synthesized RSS content from the audio device.

Audio files containing waveform data representing speech presentation of the synthesized RSS content may be played on an audio device which is not generally enabled to manage and render synthesized RSS content as described above. Such devices include, for example, audio compact disc players playing audio files encoded on compact discs which meet Compact Disc Digital Audio (‘CD-DA’) Redbook standards; Digital Audio Players (‘DAPs’), such as DAPs that play audio files in MP3 format, Ogg Vorbis format, and Windows Media Audio (‘WMA’) format; or any other thin client audio players as will occur to those of skill in the art. Publishing synthesized RSS content as an audio file, therefore, allows the user improved flexibility in accessing the synthesized data on a device not generally enabled to manage and render synthesized RSS content, often in circumstances where visual methods of accessing the data may be cumbersome. Examples of circumstances where visual methods of accessing the data may be cumbersome include working in crowded or uncomfortable locations such as trains or cars, engaging in visually intensive activities such as walking or driving, and other circumstances as will occur to those of skill in the art.

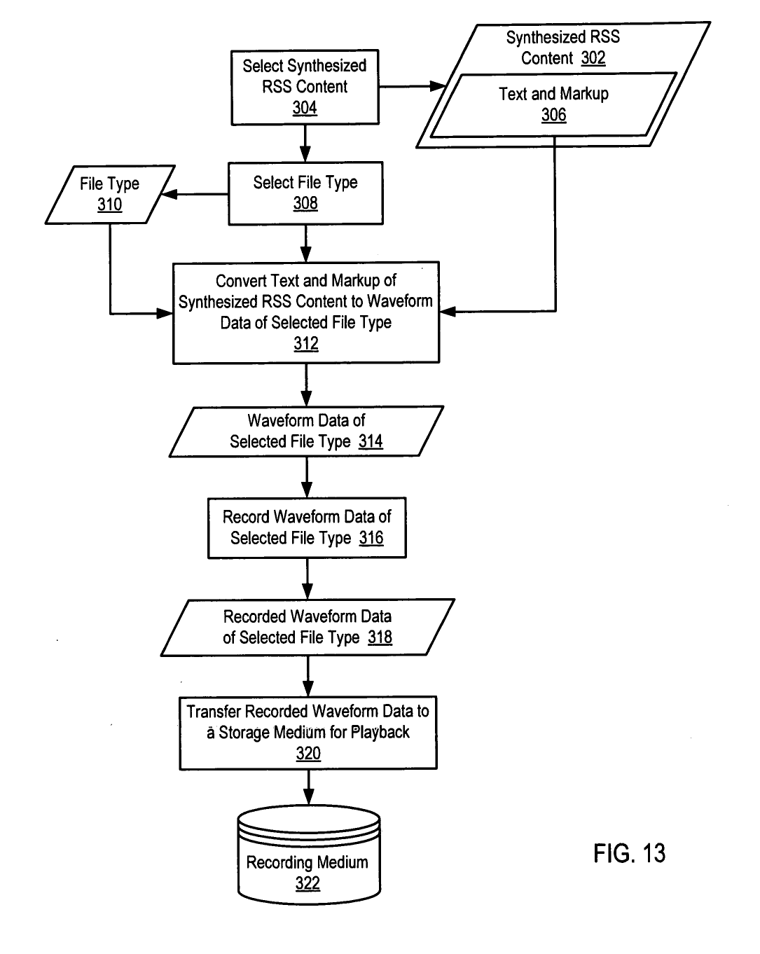

For further explanation, therefore, FIG. 13 sets forth a flow chart illustrating an exemplary method for publishing synthesized RSS content as an audio file according to the present invention. Synthesized RSS content is RSS data which has been aggregated from an RSS data source and synthesized for use in data management and data rendering according to embodiments of the present invention as discussed in more detail above.

As discussed above, RSS is a family of XML file formats for web syndication. RSS is often used for syndicating news and the content of news-like sites, including major news sites, news-oriented community sites, and personal weblogs. RSS allows users to see some of a web site's content, in the form of items which are created from the website's associated RSS feed, without requiring the user to visit the web site directly.

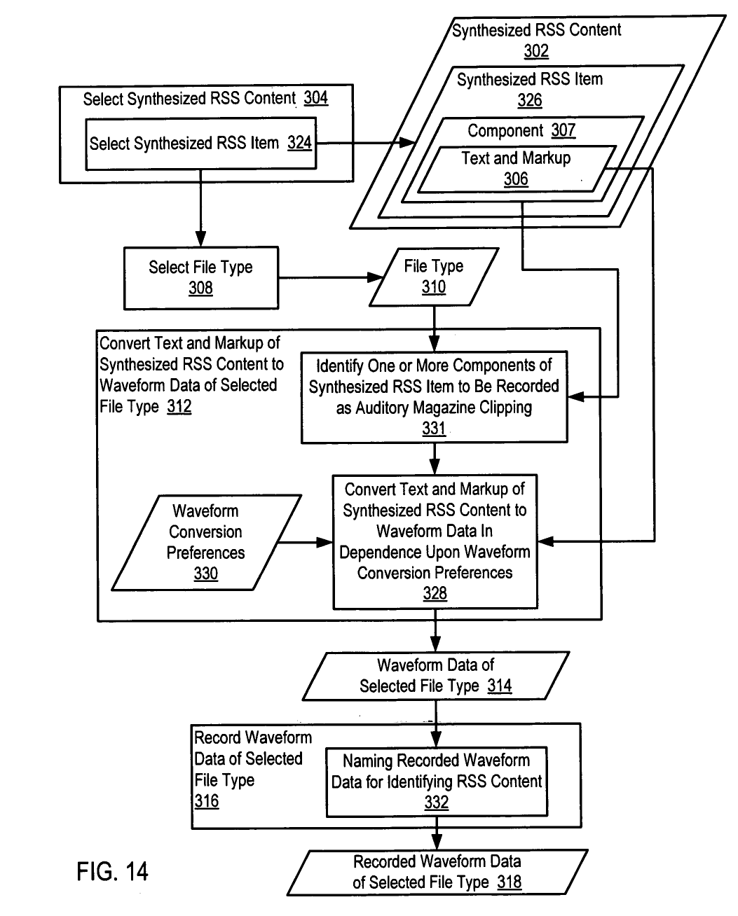

Although the aggregated native form RSS content is often translated as a collection of RSS content, the individuality of each individual RSS item in the native form RSS content is often preserved in the synthesized RSS content as an individual synthesized RSS item. A typical synthesized RSS item is composed of RSS components implemented as text and markup representing translated aspects of the individual RSS items, as will be discussed in greater detail with reference to FIG. 14 below.

Publishing synthesized RSS content as an audio file according to the method of FIG. 13 includes selecting (304) synthesized RSS content (302). Selecting (304) synthesized RSS content (302) may include selecting synthesized RSS content (302) in dependence upon a predetermined selection criterion. Examples of synthesized RSS content (302) selected in dependence upon such predetermined selection criteria include synthesized RSS content (302) that is marked as unread, synthesized RSS content with priority designations, synthesized RSS content (302) from priority RSS sources, and so on as will occur to those of skill in the art. Such predetermined selection criteria may be stored in memory available to data management and data rendering modules of the present invention.

As just mentioned above, selecting (304) synthesized RSS content (302) according to the method of FIG. 13 may be carried out by selecting synthesized RSS content (302) marked as unread. Typically, synthesized RSS content (302) may be marked as unread by setting an unread flag in a synthesized RSS item, which marks the synthesized RSS item as unread. Often browsers display read and unread synthesized RSS content (302) differently in dependence upon the setting of the unread flag. Read and unread synthesized RSS content (302) may therefore be visually distinguished. Marking a synthesized RSS item as unread may be carried out by associating a Boolean flag with the synthesized RSS item and setting the Boolean flag to either true or false. The unread flag discussed above, for example, is set to true to mark the synthesized RSS item as unread. A synthesized RSS item containing an unread flag is often initially marked as unread and so displayed in a browser. When a browser displays an unread synthesized RSS item, the browser may change the Boolean variable to indicate that the synthesized RSS item is now marked as read.

Publishing synthesized RSS content as an audio file also includes selecting (308) a file type (310). A file type (310) is a file format, that is, the particular way that information is encoded for storage on a recording medium as a computer file. Audio file formats typically fall within one of the following three categories: uncompressed formats, formats with lossless compression, and formats with lossy compression. Examples of uncompressed formats include the WAVE form audio format (‘WAV’), Audio Interchange File Format (‘AIFF’), and the Au audio file format introduced by Sun Microsystems. Uncompressed formats typically store all of a recorded sample of waveform data by digitally encoding the waveform data at a specified sampling rate and sample size.

One file format useful in publishing synthesized RSS content as an audio file is the WAV file format because WAV is the main format used on Windows systems for raw audio. WAV files typically have the file extensions ‘.wav’ and ‘.wave.’ WAV is an audio file format standard for storing audio on PCs which takes into account some peculiarities of the Intel CPU, such as little endian byte order, developed by Microsoft and IBM. WAV is a variant of the RIFF bitstream format for storing data in “chunks,” and is a flexible format for storing many types of audio data. The RIFF format acts as a “wrapper” for various audio compression encodings.

Though a WAV file can hold audio encoded with any compression technique, the most common format is audio data encoded with pulse-code modulation (‘PCM’). PCM is a digital representation of an analog signal created by sampling the magnitude of the signal regularly at uniform intervals, then quantizing the signal to a series of symbols in a digital code. PCM is used in digital telephone systems and is also the standard form for digital audio in computers and various compact disc formats.

Examples of formats with lossless compression include Free Lossless Audio Codec (‘FLAC’), Monkey's Audio, WavPack, Shorten (‘SHN’), True Audio (‘TTA’), and lossless Windows Media Audio (‘WMA’). Waveform data stored in a lossless compression format, such as FLAC, is compressed by use of data compression algorithms that allow the exact original data to be reconstructed from the compressed data.

Examples of formats with lossy compression include MP3, Ogg Vorbis, lossy Windows Media Audio (‘WMA’) and Advanced Audio Coding (‘AAC’). Waveform data stored in a lossy compression format, such as the MP3 format, provides a representation of uncompressed audio data in a much smaller size while maintaining reasonable sound quality by discarding portions of the uncompressed audio data that are considered less recognizable to human hearing.

Selecting (308) a file type (310) according to the method of FIG. 13 for publishing synthesized RSS content as an audio file may also be carried out in dependence upon context information. Context information is data describing the context in which publishing synthesized RSS content as an audio file occurs, such as, for example, state information of currently displayed synthesized data, time of day, day of week, system configuration, properties of the synthesized data, or other context information as will occur to those of skill in the art. For example, when publishing synthesized RSS content (302) as an audio file, selecting (308) a file type (310) in dependence upon context information may be carried out by identifying the context information that the laptop cover is closed and that the day is Saturday and selecting the file type ‘MP3,’ which has been predesignated as a default file type corresponding to the context information that the laptop cover is closed and the day is Saturday.

Publishing synthesized RSS content as an audio file according to the method of FIG. 13 also includes converting (312) the text and markup (306) of synthesized RSS content (302) to waveform data of the selected file type (314), the waveform data containing speech presentation of synthesized RSS content (302), and recording (316) the waveform data of the selected file type (314). Converting (312) the text and markup (306) of the synthesized RSS content (302) to waveform data of the selected file type (310) may be carried out by processing the synthesized RSS content (302) using a text-to-speech engine in order to produce waveform data representing speech presentation of the synthesized RSS content (302) and then recording the speech produced by the text-to-speech engine.

Examples of speech engines capable of converting text and markup of synthesized RSS content (302) to waveform data of a selected file type include, for example, IBM's ViaVoice Text-to-Speech, Acapela Multimedia TTS, AT&T Natural Voices™ Text-to-Speech Engine, and Python's pyTTS class. Each of these text-to-speech engines is composed of a front end that takes input in the form of text and markup and outputs a symbolic linguistic representation and a back end that outputs the received symbolic linguistic representation as a synthesized speech waveform.

Typically, speech synthesis engines operate by using one or more of the following categories of speech synthesis: articulatory synthesis, formant synthesis, and concatenative synthesis. Articulatory synthesis uses computational biomechanical models of speech production, such as models for the glottis and the moving vocal tract. Typically, an articulatory synthesizer is controlled by simulated representations of muscle actions of the human articulators, such as the tongue, the lips, and the glottis. Computational biomechanical models of speech production solve time-dependent, 3-dimensional differential equations to compute the synthetic speech output. Typically, articulatory synthesis has very high computational requirements, and has lower results in terms of natural-sounding fluent speech than the other two methods discussed below.

Formant synthesis uses a set of rules for controlling a highly simplified source-filter model that assumes that the glottal source is completely independent from a filter which represents the vocal tract. The filter that represents the vocal tract is determined by control parameters such as formant frequencies and bandwidths. Each formant is associated with a particular resonance, or peak in the filter characteristic, of the vocal tract. The glottal source generates either stylized glottal pulses for periodic sounds and generates noise for aspiration. Formant synthesis generates highly intelligible, but not completely natural sounding speech. However, formant synthesis has a low memory footprint and only moderate computational requirements.

Concatenative synthesis uses actual snippets of recorded speech that are cut from recordings and stored in an inventory or voice database, either as waveforms or as encoded speech. These snippets make up the elementary speech segments such as, for example, phones and diphones. Phones are composed of a vowel or a consonant, whereas diphones are composed of phone-to-phone transitions that encompass the second half of one phone plus the first half of the next phone. Some concatenative synthesizers use so-called demi-syllables, in effect applying the diphone method to the time scale of syllables. Concatenative synthesis then strings together, or concatenates, elementary speech segments selected from the voice database, and, after optional decoding, outputs the resulting speech signal. Because concatenative systems use snippets of recorded speech, concatenative systems have the highest potential for sounding like natural speech, but concatenative systems require large amounts of database storage for the voice database.

Converting (312) the text and markup (306) of the synthesized RSS content (302) to waveform data of the selected file type (314) using a text-to-speech engine in order to produce waveform data representing speech presentation of the synthesized RSS content (302) may produce a bitstream of waveform data which is then typically recorded as an uncompressed waveform file format, such as, for example, WAV format. Alternatively, converting (312) the text and markup (306) of the synthesized RSS content (302) to waveform data of the selected file type (314) using a text-to-speech engine may directly result in an uncompressed waveform file, such as, for example, a WAV file.

For further explanation, the following exemplary computer program instructions are provided for converting text to waveform data using a text-to-speech engine that employs the Microsoft Speech API with Python's pyTTS class import pyTTS

import pyTTS
tts = pyTTS.Create( )
tts.SpeakToWave(test.wav’, ‘This is only a test.’)

In the above exemplary computer program instructions for converting text to waveform data, the instruction “import pyTTS” makes available Python's pyTTS class. The instruction “tts=pyTTS.Create()” creates a new instance of a speech engine defined in Python's pyTTS class. The instruction “tts.SpeakToWave(test.wav’, ‘This is only a test.’)” invokes the method tts.SpeakToWave() parameterized with the text ‘This is only a test’ to be converted to waveform data and the filename ‘test.wav’ instructing the method to convert the text to waveform data in the WAV file format and name the file ‘text’. Invoking the method converts the text “This is only a test” into waveform data representing the speech presentation of the text and stores the waveform data as a WAV file named “test.wav.”

Consider for further explanation a single line of code for converting text to waveform data using a text-to-speech engine that employs the FreeTTS speech synthesis system, written in the Java™ programming language.
% java -jar lib/freetts.jar -file my_RSS.txt -dumpAudio test.wav

In the example line of code above, “% java -jar lib/freetts.jar” starts the FreeTTS text-to-speech engine, “-file synthisized_RSS.txt” identifies to the speech engine a name of the file “synthesized_RSS.txt” that contains the text which will be converted to waveform data, and “-dumpAudio test.wav” instructs the speech engine to record that the waveform data representing the speech presentation of the text in the WAV file named “test.wav.”

Waveform data converted from synthesized RSS content may be recorded in either an uncompressed file format or a compressed filed format. To record the waveform data as an uncompressed file format, converting the text and markup (306) of the synthesized RSS content (302) to waveform data of the selected file type (314) results in an uncompressed file format such as a WAV file and that uncompressed file format is then directly recorded as waveform data in uncompressed file format.

To record the waveform data as a compressed file format, converting the text and markup (306) of the synthesized RSS content (302) to waveform data of the selected file type (314) is unchanged and also results in an uncompressed file format such as a WAV file. The uncompressed file format is then compressed and recorded as waveform data in compressed file format, such as MP3. The MP3 format is one popular compressed audio file format. Due to the small file size as compared to uncompressed files, such as WAV files, MP3 files are faster to download from the Internet and take up less space in storage on a computer's hard disc and on DAPs.

To make recorded waveform data of a selected file type (318) available for playback on another device, publishing synthesized RSS content as an audio file according to FIG. 13 also includes transferring (320) the recorded waveform data of the selected file type (318) to a recording medium (322) for playback. The recording medium of FIG. 13 may be any recording medium which supports the audio playback of the recorded waveform data (318), including, for example, Compact Disc Digital Audio (‘CD-DA’), Compact Disc-Recordable (‘CD-R’), Compact Disc-ReWritable (‘CD-RW’), flash memory, hard disk drive, and any other recording medium as will occur to those of skill in the art. Transferring (320) the recorded waveform data of the selected file type (318) to a recording medium (322) for playback may include inserting the recorded waveform data (318) in a location in an ordered series of recorded RSS items in dependence upon RSS item ordering criteria, creating an audio compact disk having tracks, storing the recorded waveform data in the hard drive or flash memory of a Digital Audio Player (‘DAP’), and other ways of transferring the recorded waveform data of the selected file type to a recording medium that will occur to those of skill in the art.

As discussed above, publishing synthesized RSS content as an audio file according to the present invention includes selecting synthesized RSS content, converting the text and markup of the synthesized RSS content to waveform data of the selected file type, and recording the waveform data of the selected file type. For further explanation, FIG. 14 sets forth a flow chart further illustrating exemplary methods for selecting synthesized RSS content, converting the text and markup of the synthesized RSS content to waveform data of the selected file type, and recording the waveform data of the selected file type.

Selecting (304) synthesized RSS content (302) according to the method of FIG. 14 includes selecting (324) a synthesized RSS item (326). A synthesized RSS item (326) is a component (307) of synthesized RSS content (302) representing a distinct collection of information from a native RSS feed. As discussed above, a typical synthesized RSS item (326) is composed of RSS components (307) implemented as text and markup (306) representing translated aspects of individual native RSS items. An RSS component (307) is one or more constituent parts of a synthesized RSS item (326). Such constituent parts are typically derived directly from one or more translated aspects of the individual native form RSS item from which the synthesized RSS item (326) was created. Translated aspects of the individual native RSS items may include sub-elements of the individual native RSS items, such as, for example, a description element, a title element, a link element, an author element, a guid element, a pubdate element, and a source element.

For further explanation, consider an exemplary synthesized RSS item (326) which represents an article on a web site. Such an article on a web page is analogous to a story in a newspaper or magazine, but is published on a website and is syndicated by an RSS feed:

< synthesized RSS item ID=1212 >
<description>The Aurora, Illinois Spring Festival benefited from good
weather, but attendance was poor due to several unforeseeable
problems.</description>
<title> Sun Not Enough for Aurora's Spring Festival </title>
<link>www.dailyaurorannews.com/ed/2005/Apr/14/som.html</link>
<author> bobjones@www.dailyaurorannews.com </author>
<guid>http:// www.dailyaurorannews.com /RSSItem322307</guid>
<pubdate>Thur, 14 April, 2005 13:21:31 CST</pubdate>
<source url= “http:// www.dialyaurorannews.com/links2.xml”>Sun Not
Enough for Aurora's Spring Festival</source>
</ synthesized RSS item >

In the exemplary synthesized RSS item (326) above, the synthesized RSS item (326) with the unique synthesized RSS item ID 1212, is denoted by the markup tags <synthesized RSS item ID=1212> and </synthesized RSS item>. Markup tags <description>, </description>, <title>, </title>, <link>, </link>, <author>, </author>, <pubdate>, </pubdate>, <source>, and </source> represent RSS components which are used to provide information about the native RSS item. In the example above, an item with the title component “Sun Not Enough for Aurora's Spring Festival” has a short description of the article which the item represents as a description component: “The Aurora, Illinois Spring Festival benefited from good weather, but attendance was poor due to several unforeseeable factors.” In the same example, the synthesized RSS item (326) contains a URL in a link component, “www.dialyaurorannews.com/ed/2005/Apr./14/som.html.” This URL may be selected in order to access the entire article. The synthesized RSS item's markup also provides the email address of the author of the article, which is “bobjones@www.dialyaurorannews.com.” The item's markup designates the publication date of the article as Thursday, Apr. 14, 2005 at 1:21 pm CST. The item's markup also designates the original source of the RSS feed, corresponding to the website hosting the article listed above, as “http://www.dialyaurorannews.com/links2.xml.”

Selecting (324) a synthesized RSS item (326) may be carried out in dependence upon a predetermined selection criterion. Examples of synthesized RSS items (326) selected in dependence upon such predetermined selection criteria include a synthesized RSS item (326) that is marked as unread, a synthesized RSS item (326) with priority designations, a synthesized RSS item (326) from a priority RSS source, a synthesized RSS item (326) having a component (307) containing one or more keywords matching a keyword search for a topic of interest, and so on as will occur to those of skill in the art. Such predetermined selection criteria may be stored in memory available to data management and data rendering modules of the present invention.

Selecting (324) a synthesized RSS item (326) may also be carried out by receiving a user instruction and selecting one or more synthesized RSS items (326) in response to the user instruction. A user instruction is an event received in response to an act by a user. Exemplary user instructions include receiving events as a result of a user entering a combination of keystrokes using a keyboard or keypad, receiving speech from a user, receiving an event as a result of clicking on icons on a visual display by using a mouse, receiving an event as a result of a user pressing an icon on a touchpad, or other user instructions as will occur to those of skill in the art. Receiving a user instruction may be carried out by receiving speech from a user, converting the speech to text, and determining in dependence upon the text and a grammar the user instruction. Alternatively, receiving a user instruction may be carried out by receiving speech from a user and determining the user instruction in dependence upon the speech and a grammar.

Consider for example, selecting (324) a synthesized RSS item (326) from the following three examples of synthesized RSS items (326) in dependence upon a predetermined selection criteria, with the predetermined selection criterion being a high priority level:

```
<synthesized RSS item ID=1111>
      <description>The summer is hot.</description>
      <title>Hot Summer</title>
      <priority>low</priority>
</synthesized RSS item>
<synthesized RSS item ID=1114>
      <description>The spring is rainy.</description>
      <title>Rainy Spring</title>
      <priority>low</priority>
</synthesized RSS item>
<synthesized RSS item ID=1211>
      <description>The winter is cold.</description>
      <title>Cold Winter</title>
      <priority>high</priority>
</synthesized RSS item>
```

In the exemplary synthesized RSS items (326) above, the synthesized RSS item (326) with the unique synthesized RSS item ID 1111, is denoted by the markup tags as <description>, </description>, <title>, </title>, <priority>, and </priority > represent RSS components created during synthesis, as described above. In the example above, an item with the title component “Hot Summer” has a short description of the article which the synthesized RSS item (326) represents as a description component: “The summer is hot.” The same exemplary synthesized RSS item (326) contains a priority level of “low” in a priority component. In this example, the predetermined selection criterion is a priority level of “high,” and therefore this example of a synthesized RSS item (326), is not selected.

In the exemplary synthesized RSS items (326) above, the synthesized RSS item (326) with the unique synthesized RSS item ID 1114, is denoted by the markup tags <synthesized RSS item ID=1114> and </synthesized RSS item>. Markup tags such as <description>, </description>, <title>, </title>, <priority>, and </priority > represent RSS components (307) created during synthesis, as described above. In the example above, an item with the title component “Rainy Spring” has a short description of the article which the synthesized RSS item (326) represents as a description component: “The spring is rainy.” The same exemplary synthesized RSS item (326) contains a priority level of “low” in a priority component. In this example, the predetermined selection criterion is a priority level of “high,” and therefore this example of a synthesized RSS item (326), is not selected.

In the exemplary synthesized RSS items (326) above, the synthesized RSS item (326) with the unique synthesized RSS item ID 1211, is denoted by the markup tags <synthesized RSS item ID=1211> and </synthesized RSS item>. Markup tags such as <description>, </description>, <title>, </title>, <priority>, and </priority > represent RSS components created during synthesis, as described above. In the example above, an item with the title component “Cold Winter” has a short description of the article which the synthesized RSS item (326) represents as a description component: “The winter is cold.” The same exemplary synthesized RSS item (326) contains a priority level of “high” in a priority component. In this example, because the predetermined selection criterion is a priority level of “high”, this example of a synthesized RSS item (326), is selected.

Because the predetermined selection criterion for selecting (324) a synthesized RSS item (326) was a priority component with a value equal to “high,” the synthesized RSS item (326) with the unique synthesized RSS item ID 1211 is selected, because this synthesized RSS item has a priority component equal to “high.” The synthesized RSS items (326) with the unique synthesized RSS item IDs 1111 and 1114 are not selected because neither of these synthesized RSS items have a priority component equal to “high.”

As discussed above, publishing synthesized RSS content (302) as an audio file according to the method of the present invention also includes converting (312) the text and markup (306) of synthesized RSS content (302) to waveform data of the selected file type (314), the waveform data containing speech presentation of synthesized RSS content (302), and recording (316) the waveform data of the selected file type (314). The recorded waveform data may be implemented as one or more auditory magazine clippings containing a speech presentation of the synthesized RSS content (302).

An auditory magazine clipping is an individual unit of recorded audio data which may be separately accessed from a larger collection of audio data. In the method of FIG. 14, the waveform data recorded as one or more auditory magazine clippings typically contains a speech presentation of one or more components (307) of the synthesized RSS item (326). An auditory magazine clipping may be implemented in the method of FIG. 14 as a separate file in a collection of files, or a plurality of auditory magazine clippings may be implemented as a single file with data encoded in the file indicating separate audio passages. Alternatively, an auditory magazine clipping may be implemented with subcode data encoded on an audio CD indicating separate tracks and the absolute and relative position of the laser in the track and as any other type of auditory magazine clipping in an audio appointment book as will occur to those of skill in the art. An auditory magazine clipping may contain portions of a component (307) of a synthesized RSS item (326), one component (307) of a synthesized RSS item (326), a plurality of components (307) of a synthesized RSS item (326), or a plurality of synthesized RSS items (326). For example, an auditory magazine clipping may contain the first five lines of a “description” component (307) of a synthesized RSS item (326); the entire “description” component (307) of a synthesized RSS item (326); the “link” component (307), “title” component (307), and “author” component (307), of a synthesized RSS item (326); or all of the components (307) of all the synthesized RSS items (326) having a predetermined selection criteria, or any other collection of components (307) of a synthesized RSS item (326) or collection of synthesized RSS item (326) that will occur to those of skill in the art.

Auditory magazine clippings are useful in navigating audio waveform data representing speech presentation of synthesized RSS items (326). A user who desires to listen to a speech presentation, from a legacy audio device, of a particular component (307) in a particular synthesized RSS item (326) may simply listen to the individual auditory magazine clipping containing the component (307) by conveniently navigating between individual auditory magazine clippings of the audio data using the controls of the legacy audio device.

Converting (312) the text and markup (306) of the synthesized RSS content (302) to waveform data of the selected file type (314) according to the method of FIG. 14 is carried out by converting (328) the text and markup (306) of the synthesized RSS content (302) to waveform data of the selected file type (314) in dependence upon waveform conversion preferences (330). Waveform conversion preferences (330) are preferences governing the conversion of text and markup (306) of synthesized RSS content (302) to waveform data of the selected file type (314). Examples of waveform conversion preferences include preferences for grouping components (307) of a synthesized RSS item (326) together for ultimate representation in a single track on an audio CD, preferences for excluding certain components (307) of a synthesized RSS item (326) from representation in a single auditory magazine clipping, prosody settings to be used in converting (316) the text and markup (306) of the synthesized RSS item (326) of the synthesized RSS content (302) to waveform data of the selected file type (314), and other settings that will occur to those of skill in the art.

As discussed above, selecting (304) synthesized RSS content (302) according to the method of FIG. 14 includes selecting (324) a synthesized RSS item (326) representing a distinct collection of information from the native RSS feed, with a typical synthesized RSS item (326) being composed of RSS components (307) implemented as text and markup (306) representing translated aspects of the individual native RSS items. This selected synthesized RSS item (326) may then be converted according to the method of FIG. 14. Converting (312) the text and markup (306) of synthesized RSS content (302) to waveform data of the selected file type and recording (316) the waveform data of the selected file type (314) according to FIG. 14 may be carried out by converting the text and markup (306) of the synthesized RSS items (326) to waveform data (314) of a selected file type and recording (316) the waveform data (310) as one or more auditory magazine clippings. These auditory magazine clippings typically contain a speech presentation of one or more components (307) of the synthesized RSS item (326) which has been converted.

Converting the text and markup (306) of the synthesized RSS items (326) may include processing the synthesized RSS items (326) using a text-to-speech engine in order to produce waveform data representing speech presentation of the synthesized RSS items (326) and then recording the speech produced by the text-speech-engine, in a manner similar to processing the synthesized RSS content (302) as described above. Recording the selected components (307) of the synthesized RSS items (326) as auditory magazine clippings advantageously empowers a user to navigate the selected components (307) by auditory magazine clipping. Consider for example, a number of components (307) of a number of synthesized RSS items (326) stored as a number of tracks on a compact disc. In such an example, a user is empowered to navigate past tracks containing the ‘link’ component of synthesized RSS item and quickly arrive at the ‘description’ component of the synthesized RSS item (326).

In order to record the selected components of the synthesized RSS content (302) as auditory magazine clippings according to the method of FIG. 14, converting (312) the text and markup (306) of the synthesized RSS content (302) to waveform data of a selected file type (314) also includes identifying (331) one or more components (307) of a synthesized RSS item (326) to be recorded as an auditory magazine clipping. In many cases it is advantageous to record more than one component (307) as a single auditory magazine clipping. For example, the heading information of synthesized RSS item (326), such as the information in the link, source, and title components of the synthesized RSS item, and other header information, may be recorded as a single auditory magazine clipping.

Identifying (331) a component (307) of the synthesized RSS item (326) to be recorded as an auditory magazine clipping may include identifying a predefined component designation in the synthesized RSS item (326) and selecting text and markup associated with an identified predefined component designation. A predefined component designation in the synthesized RSS item (326) may be implemented as markup in the synthesized RSS item (326) identifying the component (307). Consider for illustration the following exemplary synthesized RSS item (326) containing components (307) designated by predefined component designations implemented as text and markup including a description component designated by the markup tags <description> and </description>, a title component designated by the markup tags <title> and </title>, a link component designated by the markup tags <link> and </link>, an author component designated by the markup tags <author>and </author>, a guid component designated by the markup tags <guid> and </guid>, a pubdate component designated by the markup tags <pubdate> and </pubdate>, and a source component designated by the markup tags <source url=“http://www.dialyaurorannews.com/links2.xml”> and </source>:

<synthesized RSS item ID=1212 >
<description>The Aurora, Illinois Spring Festival benefited from good
weather, but attendance was poor due to several unforeseeable
problems.</description>
<title> Sun Not Enough for Aurora's Spring Festival </title>
<link>www.dailyaurorannews.com/ed/2005/Apr/14/som.html<link>
<author> bobjones@www.dailyaurorannews.com </author>
<guid>http:// www.dailyaurorannews.com /RSSItem322307</guid>
<pubdate>Thur, 14 April, 2005 13:21:31 CST</pubdate>
<source url= “http:// www.dialyaurorannews.com/links2.xml”>Sun Not
Enough for Aurora's Spring Festival</source>
</ synthesized RSS item >

In the exemplary synthesized RSS item (326) above, the synthesized RSS item (326) with the unique synthesized RSS item ID 1212, is denoted by the markup tags <synthesized RSS item ID=1212> and </synthesized RSS item>. Markup tags such as <description>, </description>, <title>, </title>, <link>, </link>, <author>, </author>, <pubdate>, </pubdate>, <source>, and </source> represent RSS components which are used to advantageously provide information about the native RSS item. In the example above, an item with the title component “Sun Not Enough for Aurora's Spring Festival” has a short description of the article which the item represents as a description component: “The Aurora, Ill. Spring Festival benefited from good weather, but attendance was poor due to several unforeseeable factors.” In the same example, the synthesized RSS item (326) contains a URL in a link component, “www.dialyaurorannews.com/ed/2005/Apr./14/som.html.” This URL may be selected in order to access the entire article. The synthesized RSS item's markup also provides the email address of the author of the article, which is “bobjones@www.dialyaurorannews.com.” The item's markup designates the publication date of the article as Thursday, Apr. 14, 2005 at 1:21 pm CST. The item's markup also designates the original source of the RSS feed, corresponding to the website hosting the article listed above, as “http://www.dialyaurorannews.com/links2.xml.”

Identifying (331) components (307) of the synthesized RSS item (326) above to be recorded as an auditory magazine clipping includes identifying the predefined component designations <description></description>, <title></title>, <link></link>, <author></author>, <guid></guid>, <pubdate></pubdate>, and <source></source> in the synthesized RSS item (326) above and selecting the associated text and markup, <description> The Aurora, Ill. Spring Festival benefited from good weather, but attendance was poor due to several unforeseeable problems.</description>, <title> Sun Not Enough for Aurora's Spring Festival </title>, <link>www.dailyaurorannews.com/ed/2005/Apr./14/som.html</link>, <author>bobjones@www.dailyaurorannews.com </author>, <guid>http://www.dailyaurorannews.com /RSSItem322307</guid>, <pubdate>Thur, 14 Apr., 2005 13:21:31 CST</pubdate>, and <source url=“http://www.dialyaurorannews.com/links2.xml”> Sun Not Enough for Aurora's Spring Festival</source> associated with the identified predefined component designations to be included as auditory magazine clippings.

The exemplary synthesized RSS item (326) above is presented for explanation and not for limitation. In fact, synthesized RSS items (326) according to the present invention may be implemented in many ways and all such implementations are well within the scope of the present invention.

In the method of FIG. 14, recording (316) the waveform data of the selected file type (314) according to the method of FIG. 14 further includes naming (332) the recorded waveform data for identifying the RSS content. Naming (332) the recorded waveform data for identifying the RSS content may be carried out by naming an auditory magazine clipping for identifying the one or more components of the synthesized RSS item (326) recorded as an auditory magazine clipping. Naming an auditory magazine clipping for identifying the one or more components of the synthesized RSS item (326) recorded as an auditory magazine clipping may include naming the auditory magazine clipping in dependence upon the synthesized RSS item (326) and upon information contained in the components of the synthesized RSS item (326) represented within the auditory magazine clipping. Consider for further illustration the example of naming an auditory magazine clipping as a WAV file containing the “description” component of an individual synthesized RSS item (326) having a synthesized RSS item ID ‘1244’ having the “title” component “Fun in the Sun.” In this example, naming the auditory magazine clipping is carried out by naming an auditory magazine clipping containing the “description” component of the individual synthesized RSS item (326) according to the synthesized RSS item's synthesized RSS item ID number ‘1244’, the component name (description), and title of the synthesized RSS item (326) resulting in the filename 1244-Fun_in_the_Sun-description.wav.

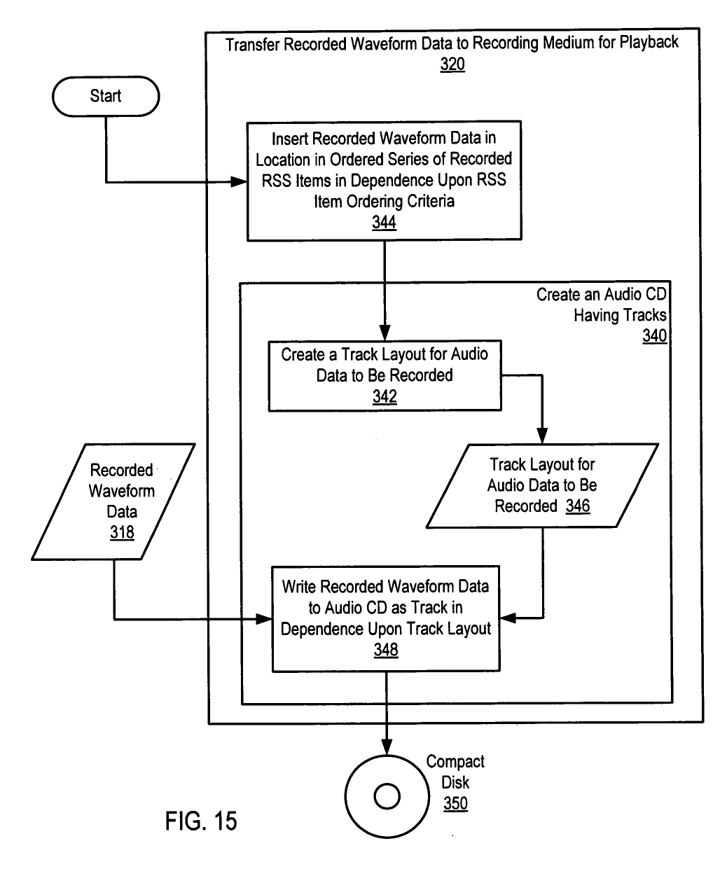

As discussed above with reference to FIG. 13, publishing synthesized RSS content as an audio file according to the present invention may also include transferring recorded waveform data of a selected file type to a recording medium for playback. For further explanation, FIG. 15 sets forth a flow chart further illustrating transferring recorded waveform data of a selected file type to a recording medium for playback. The recording medium may be any recording medium which supports the audio playback of the recorded waveform data, including, for example, Compact Disc Digital Audio (‘CD-DA’), Compact Disc-Recordable (‘CD-R’), Compact Disc-ReWritable (‘CD-RW’), flash memory, hard disk drive, and any other recording medium as will occur to those of skill in the art.

In the method of FIG. 15, transferring (320) the recorded waveform data (318) of the selected file type to a recording medium (350) for playback includes inserting (344) the recorded waveform data (318) in a location in an ordered series of recorded synthesized RSS items in dependence upon RSS ordering criteria. RSS ordering criteria are aspects of the recorded waveform data (318) which may be used to determine the order in which recorded waveform data (318) is presented, such as, for example, priority, being marked as unread, and any other RSS ordering criteria as will occur to those of skill in the art.

In the method of FIG. 15, inserting (344) the recorded waveform data (318) in a location in an ordered series of recorded synthesized RSS items in dependence upon RSS ordering criteria may be carried out by inserting an individual auditory magazine clipping in a location in an ordered series of individual auditory magazine clippings in dependence upon RSS ordering criteria. Thus RSS ordering criteria may be aspects of the individual auditory magazine clippings which may be used to determine the order in which the auditory magazine clippings are presented. Such RSS ordering criteria would still include, for example, priority, being marked as unread, and any other RSS ordering criteria for auditory magazine clippings as will occur to those of skill in the art.

In the method of FIG. 15, transferring (320) the recorded waveform data (318) of the selected file type to a recording medium (322) for playback also includes creating (340) an audio compact disc (350) having tracks. An audio compact disc (350) includes any compact disc which complies with Compact Disc Digital Audio (‘CD-DA’) Redbook standards. Such audio compact discs may be implemented as CD-DA discs, CD-R discs, CD-RW discs, or any other audio compact discs as will occur to those of skill in the art. Tracks are distinct selections from audio data, which often contain an individual work or part of a larger work, indicated by subcode data encoded on an audio CD.

Creating (340) an audio compact disc (350) having tracks according to the method of FIG. 15 includes creating (342) a track layout (346) for audio data to be recorded. A track layout (346) is a data structure containing the planned composition of an audio compact disc which is to be created. A track layout (346) may be implemented as an ‘image’ of a CD. An image of a CD is a complete and exact copy of the data as it will appear on the CD. Creating (340) an audio compact disc using a track layout (346) implemented as an ‘image’ of a CD may be carried out by copying the image directly to the disc. A track layout (346) may alternatively be implemented as a ‘virtual image’ in which the complete set of files which are to written to disc are examined and ordered, but only the file characteristics are stored. Creating (340) an audio compact disc using a track layout (346) implemented as a virtual image is carried out by reading the contents of the files and the track layout and other characteristics while the CD is being written.

In the method of FIG. 15, creating (340) an audio compact disc (350) having tracks also includes writing (348) the recorded waveform data (318) to the audio compact disc (350) as a track in dependence upon the track layout (346). Writing (348) the individual recorded waveform data (318) to the audio compact disc (350) as a track in dependence upon the track layout (346) may be carried out by heating a dye in a disc with a laser until it melts or chemically decomposes to form a readable depression or mark in the recording layer of the disc. Alternatively, writing (348) the recorded waveform data (318) to the audio compact disc (350) as a track in dependence upon the track layout (346) may be carried out by heating at varying speeds a dye in a disc with a laser to effect changes in the disc between crystalline and amorphous states with different reflective properties.

Exemplary embodiments of the present invention are described largely in the context of a fully functional computer system for publishing synthesized RSS content as an audio file. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethemets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method for publishing synthesized RSS content as an audio file, the method comprising:
selecting synthesized RSS content;
selecting a file type;
converting the text and markup of the synthesized RSS content to waveform data of the selected file type, the waveform data containing speech presentation of the synthesized RSS content; and
recording the waveform data of the selected file type.

2. The method of claim 1 wherein selecting synthesized RSS content further comprises selecting a synthesized RSS item.

3. The method of claim 1 wherein converting the text and markup of the synthesized RSS content to waveform data of the selected file type further comprises converting the text and markup of the synthesized RSS content to waveform data of a selected file type in dependence upon waveform conversion preferences.

4. The method of claim 1 wherein converting the text and markup of the synthesized RSS content to waveform data of the selected file type further comprises identifying one or more components of a synthesized RSS item to be recorded as an auditory magazine clipping.

5. The method of claim 4 further comprising transferring the recorded waveform data of the selected file type to a recording medium for playback.

6. The method of claim 5 wherein transferring the recorded waveform data of the selected file type to a recording medium for playback includes creating an audio compact disk having tracks, including:
creating a track layout for audio data to be recorded; and
writing the recorded waveform data to the audio compact disk as a track in dependence upon the track layout.

7. The method of claim 5 further comprising inserting the recorded waveform data in a location in an ordered series of recorded RSS items in dependence upon RSS item ordering criteria.

8. The method of claim 1 wherein recording the waveform data of the selected file type further comprises naming the recorded waveform data for identifying the RSS content.

9. A system for publishing synthesized RSS content as an audio file, the system comprising:
a computer processor;
a computer memory operatively coupled to the computer processor, the computer memory having disposed within it computer program instructions capable of:
selecting synthesized RSS content;
selecting a file type;
converting the text and markup of the synthesized RSS content to waveform data of the selected file type, the waveform data containing speech presentation of the synthesized RSS content; and
recording the waveform data of the selected file type.

10. The system of claim 9 wherein the computer memory also has disposed within it computer program instructions capable of selecting a synthesized RSS item.

11. The system of claim 9 wherein the computer memory also has disposed within it computer program instructions capable of converting the text and markup of the synthesized RSS content to waveform data of a selected file type in dependence upon waveform conversion preferences.

12. The system of claim 9 wherein the computer memory also has disposed within it computer program instructions capable of identifying one or more components of a synthesized RSS item to be recorded as an auditory magazine clipping.

13. The system of claim 12 wherein the computer memory also has disposed within it computer program instructions capable of transferring the recorded waveform data of the selected file type to a recording medium for playback.

14. The system of claim 13 wherein the computer memory also has disposed within it computer program instructions capable of creating an audio compact disk having tracks, including:
computer program instructions capable of creating a track layout for audio data to be recorded; and
computer program instructions capable of writing the recorded waveform data to the audio compact disk as a track in dependence upon the track layout.

15. The system of claim 13 wherein the computer memory also has disposed within it computer program instructions capable of inserting the recorded waveform data in a location in an ordered series of recorded RSS items in dependence upon RSS item ordering criteria.

16. The system of claim 9 wherein the computer memory also has disposed within it computer program instructions capable of naming the recorded waveform data for identifying the RSS content.

17. A computer program product for publishing synthesized RSS content as an audio file, the computer program product embodied on a computer-readable medium, the computer program product comprising:
computer program instructions for selecting synthesized RSS content;
computer program instructions for selecting a file type;
computer program instructions for converting the text and markup of the synthesized RSS content to waveform data of the selected file type, the waveform data containing speech presentation of the synthesized RSS content; and
computer program instructions for recording the waveform data of the selected file type.

18. The computer program product of claim 17 wherein computer program instructions for selecting synthesized RSS content further comprise computer program instructions for selecting a synthesized RSS item.

19. The computer program product of claim 17 wherein computer program instructions for converting the text and markup of the synthesized RSS content to waveform data of the selected file type further comprise computer program instructions for converting the text and markup of the synthesized RSS content to waveform data of a selected file type in dependence upon waveform conversion preferences.

20. The computer program product of claim 17 wherein computer program instructions for converting the text and markup of the synthesized RSS content to waveform data of the selected file type further comprise computer program instructions for identifying one or more components of a synthesized RSS item to be recorded as an auditory magazine clipping.

21. The computer program product of claim 20 further comprising computer program instructions for transferring the recorded waveform data of the selected file type to a recording medium for playback.

22. The computer program product of claim 21 wherein computer program instructions for transferring the recorded waveform data of the selected file type to a recording medium for playback include computer program instructions for creating an audio compact disk having tracks, including:
computer program instructions for creating a track layout for audio data to be recorded; and
computer program instructions for writing the recorded waveform data to the audio compact disk as a track in dependence upon the track layout.

23. The computer program product of claim 21 further comprising computer program instructions for inserting the recorded waveform data in a location in an ordered series of recorded RSS items in dependence upon RSS item ordering criteria.

24. The computer program product of claim 17 wherein computer program instructions for recording the waveform data of the selected file type further comprise computer program instructions for naming the recorded waveform data for identifying the RSS content.
